(19) United States
(12) Patent Application Publication
(10) Pub. No.: US 2022/0196302 A1
(43) Pub. Date: Jun. 23, 2022

(54) REFRIGERANT CYCLE APPARATUS

(71) Applicant: DAIKIN INDUSTRIES, LTD., Osaka-shi, Osaka (JP)

(72) Inventor: Shigeharu TAIRA, Osaka-shi (JP)

(73) Assignee: DAIKIN INDUSTRIES, LTD., Osaka-shi, Osaka (JP)

(21) Appl. No.: 17/600,778

(22) PCT Filed: Apr. 1, 2020
(86) PCT No.: PCT/JP2020/015060

§ 371 Date: Oct. 1, 2021

(30) Foreign Application Priority Data
Apr. 3, 2019 (JP) 2019-071335

(51) Int. Cl. F25B 47/00; F25B 1/04

(52) U.S. Cl. CPC F25B 47/003; F25B 2500/06; F25B 2347/00; F25B 1/04

(57) ABSTRACT

Provided is a refrigerant cycle apparatus capable of suppressing detects caused by iodine even when a refrigerant containing iodine is used. An air conditioner includes a refrigerant circuit through which a refrigerant containing iodine circulates. The refrigerant circuit includes a component that is in contact with a refrigerant containing iodine, the component being made of metal other than aluminum or an aluminum alloy, or having a content of aluminum which is equal to or less than a ratio at which corrosion of aluminum occurs by iodine. The component is at least one of a component of a compressor, a component of a heat-source-side heat exchanger or a utilization-side heat exchanger, a component of an expansion valve, a drier, and a connection pipe.

### TECHNICAL FIELD

The present disclosure relates to a refrigerant cycle apparatus.

### BACKGROUND ART

A refrigerant having a relatively low ozone depletion potential (ODP) and a refrigerant having a relatively low global warming potential (GWP) have been conventionally studied in consideration of environmental load.

For example, in Patent Literature 1 (JP 2017-149943 A), a refrigerant capable of suppressing the ozone depletion potential and the global warming potential to be low is studied.

### SUMMARY OF THE INVENTION

### <Technical Problem>

On the other hand, since a refrigerant having a low global warming potential tends to have high flammability, studies on a refrigerant containing iodine such as R466A have been recently conducted.

On the other hand, the inventors of the present application have newly found that when a refrigeration cycle is performed by filling a refrigerant circuit with a refrigerant containing iodine, defects caused by iodine may occur. In particular, the inventors of the present application have obtained a finding that there is a possibility that defects caused by iodine may occur in the presence of aluminum or an aluminum alloy.

The present disclosure provides a refrigerant cycle apparatus capable of suppressing defects caused by iodine even when a refrigerant containing iodine is used.

### <Solution to Problem>

A refrigerant cycle apparatus according to a first aspect is a refrigerant cycle apparatus having a refrigerant circuit through which a fluid containing iodine circulates. The refrigerant circuit includes a component that is in contact with the fluid. The component is made of metal in which a content of aluminum is equal to or less than a ratio at which corrosion of aluminum occurs by iodine. The component is at least one of a component of a compressor, a component of a heat exchanger, a component of a control valve, a drier, a refrigerant pipe, and a connection pipe.

The control valve is not limited, and may be, for example, an expansion valve capable of adjusting a valve opening degree, or an on-off valve that is switched between an open state and a closed state.

The connection pipe is a pipe constituting a part of the refrigerant circuit. For example, in a case where the refrigeration cycle apparatus includes a heat source unit and a utilization unit, the connection pipe is a pipe that connects the heat source unit and the utilization unit and sends the refrigerant. In a case where the refrigeration cycle apparatus includes an outdoor unit and an indoor unit, the connection pipe is a pipe that connects the outdoor unit and the indoor unit and sends the refrigerant.

The refrigerant pipe is a pipe constituting a part of the refrigerant circuit. For example, in the case where the refrigeration cycle apparatus includes the heat source unit and the utilization unit, the refrigerant pipe is a pipe that is accommodated in the heat source unit and the utilization unit and sends the refrigerant. In the case where the refrigeration cycle apparatus includes the outdoor unit and the indoor unit, the refrigerant pipe is a pipe that is accommodated in the outdoor unit and the indoor unit and sends the refrigerant.

This refrigerant cycle apparatus can suppress corrosion of at least one of the component of the compressor, the component of the heat exchanger, the component of the control valve, the drier, and the connection pipe due to iodine.

A refrigerant cycle apparatus according to a second aspect is the refrigerant cycle apparatus according to the first aspect, in which the component of the heat exchanger is a heat transfer tube included in the heat exchanger.

A refrigerant cycle apparatus according to a third aspect is the refrigerant cycle apparatus according to the first or second aspect, in which the component of the control valve is a valve body and/or a coil.

A refrigerant cycle apparatus according to a fourth aspect is the refrigerant cycle apparatus according to any one of the first to third aspects, in which the compressor is a scroll compressor. The component of the compressor is at least one of a movable scroll, a fixed scroll, an Oldham ring, a slider, a sleeve, a balance weight, and a crankshaft.

A refrigerant cycle apparatus according to a fifth aspect is the refrigerant cycle apparatus according to any one of the first to third aspects, in which the compressor is a rotary compressor. The component of the compressor is at least one of a piston, a cylinder, a balance weight, and a crankshaft.

A refrigerant cycle apparatus according to a sixth aspect is the refrigerant cycle apparatus according to any one of the first to fifth aspects, in which the component does not contain aluminum.

A refrigerant cycle apparatus according to a seventh aspect is a refrigerant cycle apparatus having a refrigerant circuit through which a fluid containing iodine circulates. The refrigerant circuit has a portion that is in contact with the fluid and is made of aluminum or an aluminum alloy. In the refrigerant circuit, there is a portion where a moisture content of the fluid is larger than a predetermined moisture content. The predetermined moisture content is a moisture content at which corrosion by iodine occurs in the portion made of the aluminum or the aluminum alloy.

With regard to corrosion of aluminum or an aluminum alloy caused by iodine, it is considered rather advantageous that the fluid contains a predetermined amount or more of moisture.

In the refrigerant cycle apparatus, since there is a portion where the moisture content of the fluid is larger than the predetermined moisture content in the refrigerant circuit, it is possible to suppress the occurrence of corrosion due to iodine in the portion made of aluminum or an aluminum alloy.

A refrigerant cycle apparatus according to an eighth aspect is the refrigerant cycle apparatus according to the seventh aspect, in which the refrigerant circuit includes a condenser for a refrigerant. A moisture content of the fluid flowing through an outlet of the condenser in the refrigerant circuit is larger than the predetermined moisture content.

A refrigerant cycle apparatus according to a ninth aspect is the refrigerant cycle apparatus according to the seventh or eighth aspect, in which the predetermined moisture content in the fluid is 75 ppm.

A refrigerant cycle apparatus according to a tenth aspect is a refrigerant cycle apparatus having a refrigerant circuit through which a fluid containing iodine circulates. The refrigerant circuit has a portion that is in contact with the fluid and is made of aluminum or an aluminum alloy. A maximum temperature of a portion in contact with the fluid flowing in the refrigerant circuit is lower than a predetermined temperature. The predetermined temperature is a temperature at which corrosion by iodine occurs in the portion made of the aluminum or the aluminum alloy.

In this refrigerant cycle apparatus, since the maximum temperature of the portion in contact with the fluid flowing in the refrigerant circuit is suppressed to be equal to or lower than the predetermined temperature, it is possible to suppress the occurrence of corrosion due to iodine in the portion made of aluminum or an aluminum alloy.

A refrigerant cycle apparatus according to an eleventh aspect is the refrigerant cycle apparatus according to the tenth aspect, wherein the predetermined temperature is 175° C.

A refrigerant cycle apparatus according to a twelfth aspect is the refrigerant cycle apparatus according to the tenth or eleventh aspect, and further includes a control unit. The refrigerant circuit includes a compressor. The control unit controls at least the compressor such that a maximum temperature of a portion that is in contact with the fluid flowing in the refrigerant circuit becomes lower than the predetermined temperature.

A refrigerant cycle apparatus according to a thirteenth aspect is the refrigerant cycle apparatus according to any one of the first to twelfth aspects, in which the fluid includes a refrigerant containing CF₃I or a mixed refrigerant containing CF₃I.

The fluid may contain refrigerating machine oil in addition to the refrigerant.

A refrigerant cycle apparatus according to a fourteenth aspect is the refrigerant cycle apparatus according to any one of the first to thirteenth aspects, in which the fluid contains R466A.

### BRIEF DESCRIPTION OF THE DRAWINGS

FIG. 1 is a perspective view showing an installation state of an air conditioner in a building, according to a first embodiment.

FIG. 2 is a perspective view showing an appearance of the air conditioner.

FIG. 3 is a perspective view showing an appearance of the air conditioner.

FIG. 4 is a perspective view for explaining an internal configuration of the air conditioner.

FIG. 5 is a perspective view for explaining an internal configuration of the air conditioner.

FIG. 6 is a right side view for explaining an internal configuration of the air conditioner.

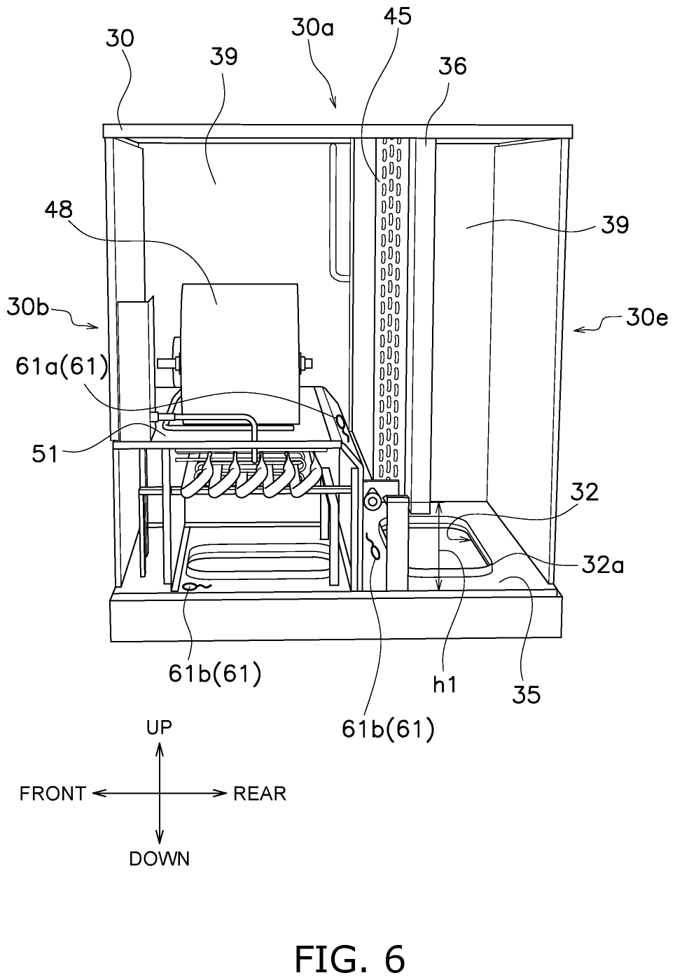

FIG. 7 is a perspective view for explaining an internal configuration of the air conditioner.

FIG. 8 is a perspective view for explaining a duct of the air conditioner.

FIG. 9 is a diagram for explaining a refrigerant circuit of the air conditioner according to the first embodiment.

FIG. 10 is a block diagram for explaining a control system of the air conditioner according to the first embodiment.

FIG. 11 is a partially enlarged perspective view of a periphery of a left side portion of a utilization-side heat exchanger.

FIG. 12 is an exemplary view for explaining a positional relationship between each member and a first opening and a second opening.

FIG. 13 is a cross-sectional side view showing a schematic configuration of a compressor according to the first embodiment.

FIG. 14 is a cross-sectional side view showing a schematic configuration of a compressor according to a modification of the first embodiment.

FIG. 15 is a cross-sectional plan view showing the periphery of a cylinder chamber of the compressor according to the modification of the first embodiment.

FIG. 16 is a cross-sectional plan view of a piston of the compressor according to the modification of the first embodiment.

FIG. 17 is an exemplary view showing an arrangement of an air conditioning system according to a second embodiment.

FIG. 18 is a schematic configuration diagram of the air conditioning system according to the second embodiment.

FIG. 19 is a schematic configuration diagram of an expansion valve according to another embodiment.

FIG. 20 is a schematic configuration diagram of a switching valve according to another embodiment.

FIG. 21 is a schematic configuration diagram of a flare connection portion according to another embodiment.

### DESCRIPTION OF EMBODIMENTS

### (1) First Embodiment

### (1-1) Overall Configuration

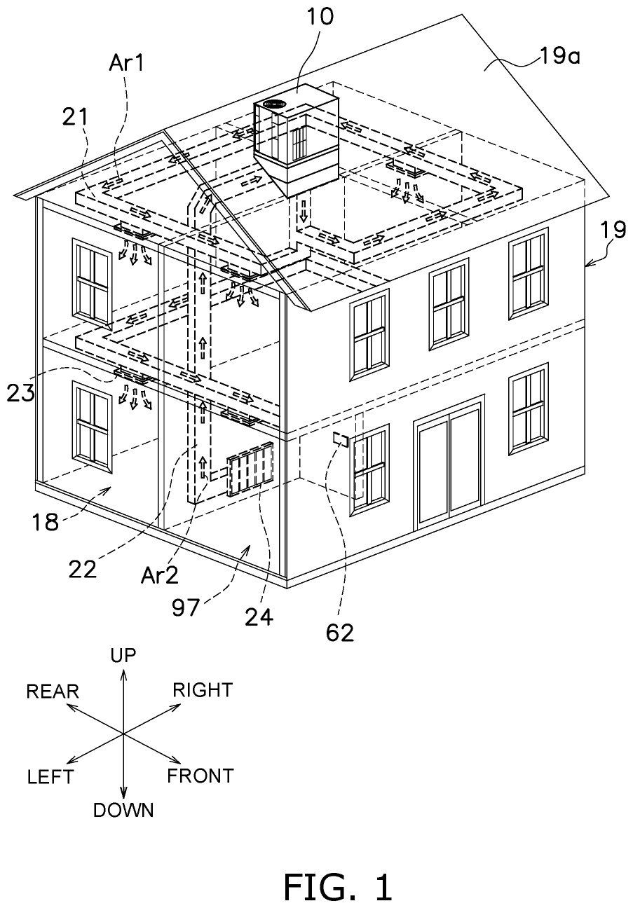

As shown in FIG. 1, an air conditioner 10 according to a first embodiment is installed on a roof 19a of a building 19, that is, on a rooftop. The air conditioner 10 is equipment that air-conditions a room that is inside the building 19. The building 19 has a plurality of rooms 18. The room 18 of the building 19 is to be an air conditioning target space for the air conditioner 10. FIG. 1 shows an example in which the air conditioner 10 includes one duct 21 and one duct 22. However, the air conditioner 10 can also include a plurality of the ducts 21 and the ducts 22 individually. Note that the duct 21 shown in FIG. 1 is branched in a middle. The duct 21 is provided for supply air, and the duct 22 is provided for return air. In FIG. 1, arrows Ar1 and Ar2 in the ducts 21 and 22 indicate directions in which air in the ducts 21 and 22 is flowing. Air is sent from the air conditioner 10 to the room 18 through the duct 21, and indoor air in the room 18, which is air in the air conditioning target space, is sent to the air conditioner 10 through the duct 22. At a boundary between the duct 21 and the room 18, a plurality of blow-out ports 23 are provided. Supply air supplied through the duct 21 is blown out from the blow-out ports 23 to the room 18. Further, at a boundary between the duct 22 and the room 18, at least one suction port 24 is provided. Indoor air suctioned from the suction port 24 becomes return air to be returned to the air conditioner 10 by the duct 22.

A refrigerant circuit 11 of the air conditioner 10 is not limited, but is filled with a refrigerant including only CF₃I or a mixed refrigerant including CF₃I. As such a refrigerant, for example, a refrigerant such as R466A can be used as a refrigerant containing R32, R125, and CF₃I. Here, the content of CF₃I in the refrigerant is not limited, but may be, for example, 5 wt % or more and 70 wt % or less, and is preferably 20 wt % or more and 50 wt % or less.

Here, these refrigerants containing iodine are preferable in that they have low flammability and both the ozone depletion potential (ODP) and the global warming potential (GWP) are easily balanced with low values. Refrigerating machine oil is sealed in the refrigerant circuit 11 together with the refrigerant.

### (1-2) Appearance of Air Conditioner 10

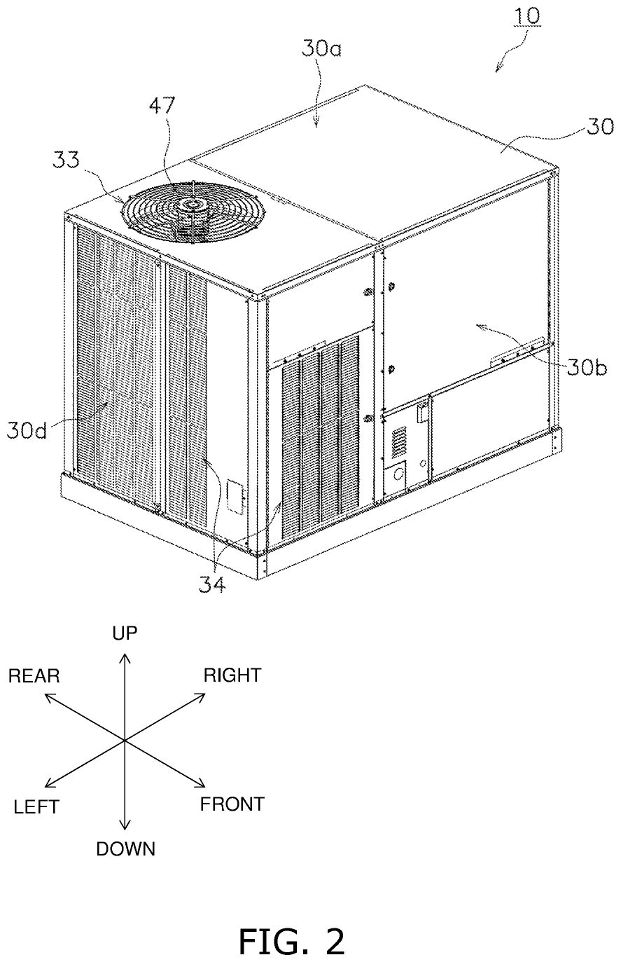

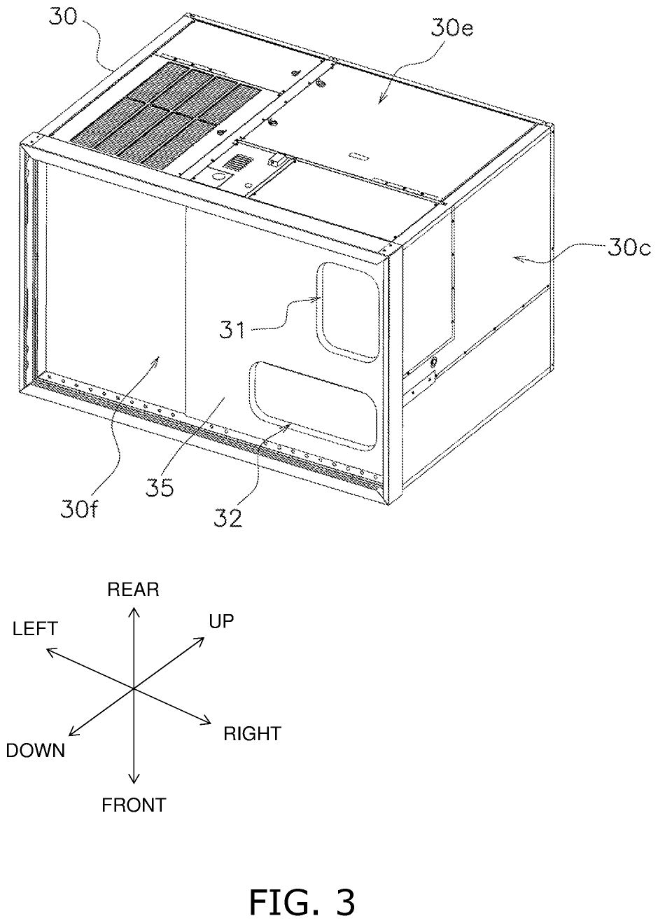

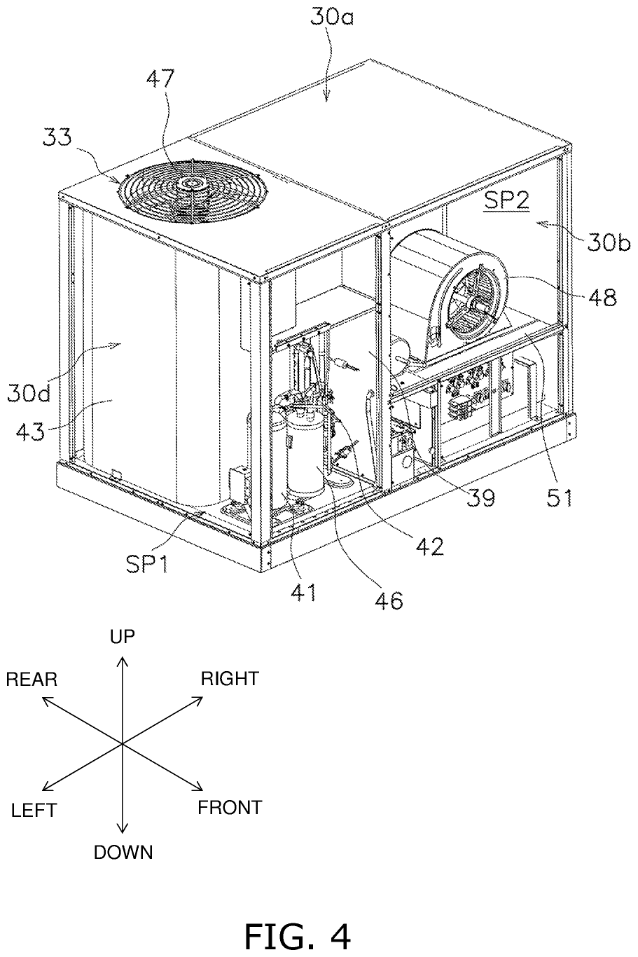

FIG. 2 shows an appearance of the air conditioner 10 when the air conditioner 10 is viewed from diagonally above, and FIG. 3 shows an appearance of the air conditioner 10 when the air conditioner 10 is viewed from diagonally below. In the following, for convenience, a description is given with use of directions, up, down, front, rear, left, and right shown by arrows in the figure. The air conditioner 10 includes a casing 30 having a shape based on a rectangular parallelepiped. The casing 30 includes a metal plate covering a top surface 30a, a front surface 30b, a right side surface 30c, a left side surface 30d, a back surface 30e, and a bottom surface 30f. The casing 30 has a third opening 33 on the top surface 30a. This third opening 33 communicates with a heat-source-side space SP1 (see FIG. 4). The third opening 33 is attached with a heat-source-side fan 47 that blows air from the heat-source-side space SP1 toward outside the casing 30 through the third opening 33. For the heat-source-side fan 47, for example, a propeller fan is used. Further, the casing 30 has slits 34 on the front surface 30b, the left side surface 30d, and the back surface 30e. These slits 34 also communicate with the heat-source-side space SP1. When air is blown out from the heat-source-side space SP1 toward outside the casing 30 by the heat-source-side fan 47, since the heat-source-side space

SP1 is to have negative pressure with respect to atmospheric pressure, outdoor air is suctioned into the heat-source-side space SP1 from the outside of the casing 30 through the slits 34. Note that the third opening 33 and the slits 34 do not communicate with a utilization-side space SP2 (see FIG. 4). Therefore, in a normal state, there is no place where the utilization-side space SP2 communicates with the outside of the casing 30, other than the ducts 21 and 22.

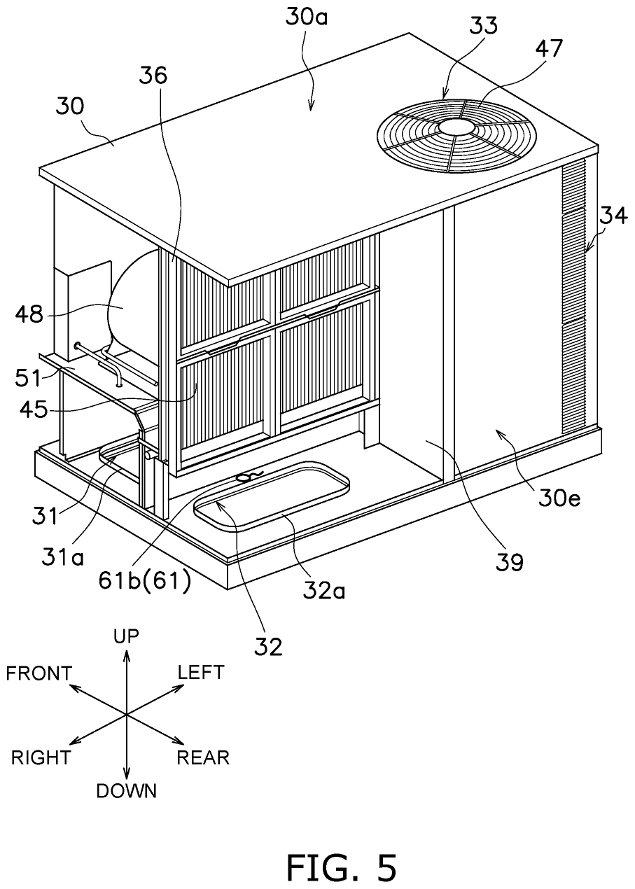

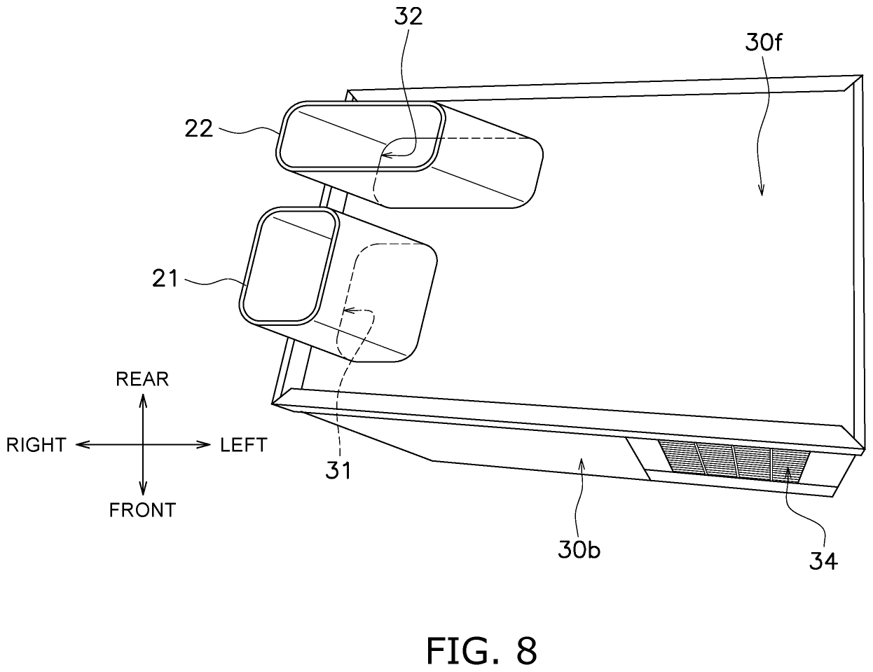

The bottom surface 30f of the casing 30 is attached with a bottom plate 35 having a first opening 31 and a second opening 32. To the first opening 31 for supply air, the duct 21 is connected as shown in FIG. 8. Further, to the second opening 32 for return air, the duct 22 is connected as shown in FIG. 8. Air that has returned from the room 18, which is the air conditioning target space, through the duct 22 to the utilization-side space SP2 of the casing 30 is sent from the utilization-side space SP2 to the room 18 through the duct 21. At a periphery of the first opening 31 and the second opening 32, ribs 31a and 32a having a height of less than 3 cm are formed in order to reinforce strength of the bottom plate 35 (see FIG. 5). When the first opening 31 and the second opening 32 are formed on the bottom plate 35 by, for example, press molding, the ribs 31a and 32a are formed integrally with the bottom plate 35 by erecting a metal plate, which is a material of the bottom plate 35, by press molding.

### (1-3) Internal Configuration of Air Conditioner 10

### (1-3-1) Heat-Source-Side Space SP1 and Utilization-Side Space SP2 in Casing 30

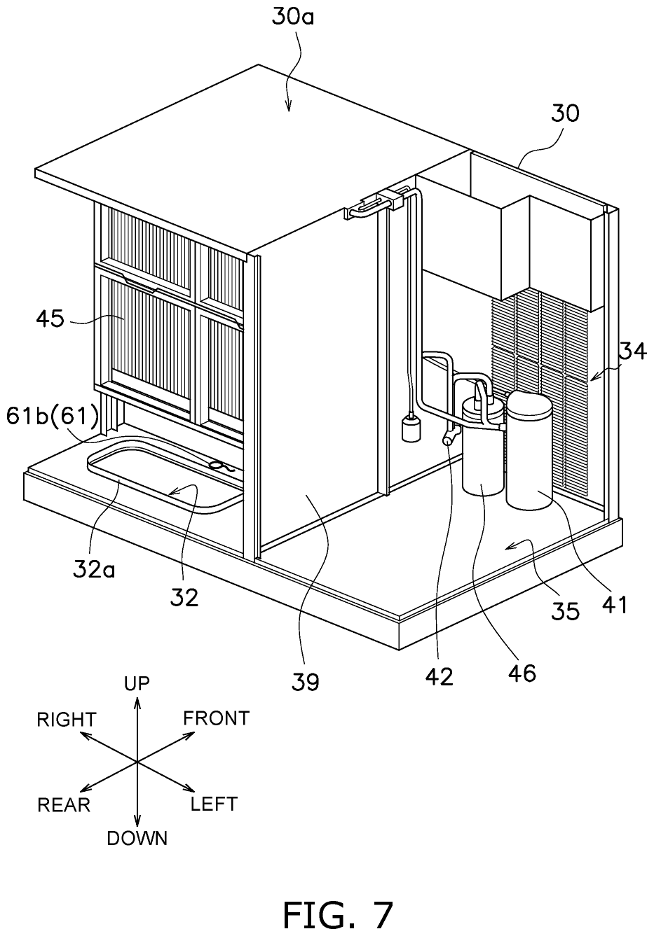

FIG. 4 shows a state in the casing 30 where a metal plate that has been covering the front surface 30b and a metal plate that has been covering the left side surface 30d are removed. FIG. 5 shows a state in the casing 30 where a metal plate that has been covering the right side surface 30c and a part of a metal plate that has been covering the back surface 30e are removed. In FIG. 5, the removed metal plate in the metal plate that has been covering the back surface 30e is a metal plate that has been covering the utilization-side space SP2. Therefore, a metal plate covering the back surface 30e shown in FIG. 5 covers only the heat-source-side space SP1. Then, FIG. 7 shows a state in the casing 30 where the metal plate that has been covering the right side surface 30c, the metal plate that has been covering the left side surface 30d, the metal plate that has been covering the back surface 30e, and the metal plate that has been covering a part of the top surface 30a are removed, and the heat-source-side heat exchanger 43 and the heat-source-side fan 47 are removed.

The heat-source-side space SP1 and the utilization-side space SP2 are separated by a partition plate 39. While outdoor air flows in the heat-source-side space SP1 and indoor air flows in the utilization-side space SP2, the partition plate 39 blocks a flow of air between the heat-source-side space SP1 and the utilization-side space SP2 by separating the heat-source-side space SP1 and the utilization-side space SP2. Therefore, in a normal state, indoor air and outdoor air do not mix in the casing 30, and there is no communication between outdoors and indoors through the air conditioner 10.

### (1-3-2) Configuration in Heat-Source-Side Space SP1

In addition to the heat-source-side fan 47, the heat-source-side space SP1 also accommodates a compressor 41, a four-way valve 42, the heat-source-side heat exchanger 43, and an accumulator 46.

The compressor 41 is not limited, but in the present embodiment, for example, a scroll compressor described later can be used.

The heat-source-side heat exchanger 43 includes a plurality of heat transfer tubes (not shown) through which a refrigerant flows, and a plurality of heat transfer fins (not shown) in which air flows through gaps between with each other. The plurality of heat transfer tubes are arranged aligned in an up-down direction (hereinafter, also referred to as a row direction), and each heat transfer tube extends in a direction (substantially in a horizontal direction) substantially orthogonal to the up-down direction. Further, the plurality of heat transfer tubes are provided in a plurality of rows in order from a side closest to the casing 30. The heat transfer tube is made of metal in which the content of aluminum is equal to or less than a ratio at which corrosion of aluminum occurs by iodine. When the content of aluminum or an aluminum alloy in the heat transfer tube is zero, the heat transfer tube is made of metal other than aluminum or an aluminum alloy. Examples of the metal other than aluminum or an aluminum alloy include copper, a copper alloy, iron, an alloy containing iron, and stainless steel. At an end portion of the heat-source-side heat exchanger 43, for example, the heat transfer tubes are bent in a U shape or connected to each other by a U-shaped tube such that a flow of the refrigerant is folded back from one column to another column and/or from one row to another row. The plurality of heat transfer fins extending long in the up-down direction are arranged along an extending direction of the heat transfer tubes at a predetermined distance from each other. The plurality of heat transfer fins and the plurality of heat transfer tubes are combined such that the plurality of heat transfer tubes penetrate individual heat transfer fins. Then, the plurality of heat transfer fins are also arranged in a plurality of rows.

The heat-source-side heat exchanger 43 has a C-shape in top view, and is arranged so as to face the front surface 30b, the left side surface 30d, and the back surface 30e of the casing 30. A portion not surrounded by the heat-source-side heat exchanger 43 is a portion facing the partition plate 39. Then, side end portions corresponding to two end portions of the C-shape are arranged near the partition plate 39, and a space between the two side end portions of the heat-source-side heat exchanger 43 and the partition plate 39 is closed by a metal plate (not shown) that blocks passage of air. Further, the heat-source-side heat exchanger 43 has a height substantially reaching from the bottom surface 30f to the top surface 30a of the casing 30. Such a configuration allows formation of a flow path of air that enters through the slit 34, passes through the heat-source-side heat exchanger 43, and exits from the third opening 33.

Outdoor air suctioned into the heat-source-side space SP1 through the slit 34 exchanges heat with the refrigerant flowing in the heat-source-side heat exchanger 43, when passing through the heat-source-side heat exchanger 43. The air after heat exchange in the heat-source-side heat exchanger 43 is exhausted from the third opening 33 to the outside of the casing 30 by the heat-source-side fan 47.

### (1-3-2-1) Details of Compressor 41

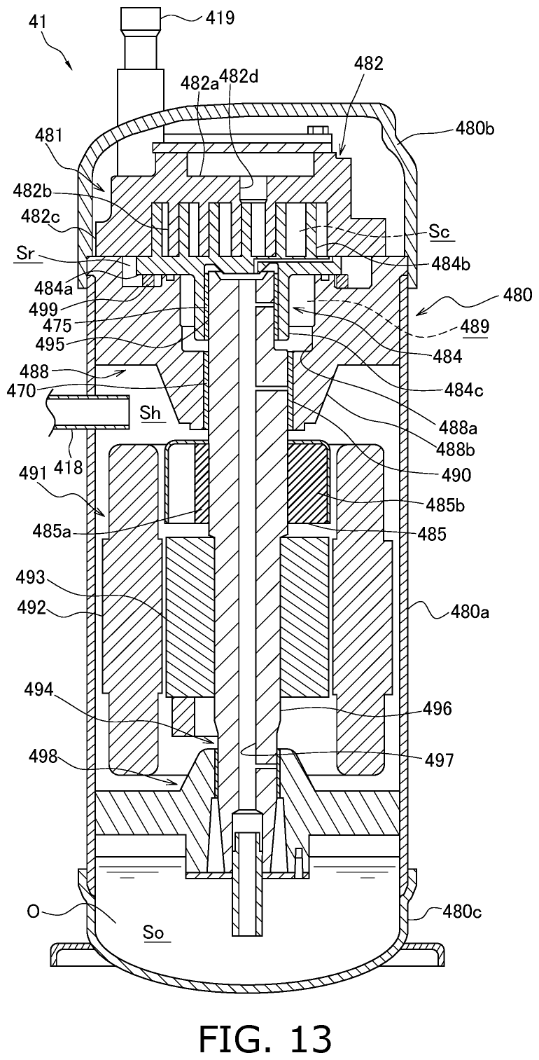

As the compressor 41, for example, a scroll compressor as shown in FIG. 13 can be used.

The compressor 41 includes a casing 480, a scroll compression mechanism 481 including a fixed scroll 482, a drive motor 491, a crankshaft 494, a balance weight 485, and a lower bearing 498.

The casing 480 includes a cylindrical member 480a that has a substantially cylindrical shape and is vertically opened, and an upper lid 480b and a lower lid 480c respectively provided at an upper end and a lower end of the cylindrical member 480a. The cylindrical member 480a, and the upper lid 480b and the lower lid 480c are fixed by welding so as to maintain airtightness. The casing 480 accommodates components of the compressor 41 including the scroll compression mechanism 481, the drive motor 491, the crankshaft 494, and the lower bearing 498. An oil reservoir space So is formed in a lower portion of the casing 480. Refrigerating machine oil O for lubricating the scroll compression mechanism 481 and the like is stored in the oil reservoir space So. In an upper portion of the casing 480, a suction pipe 419 that sucks a low-pressure gas refrigerant in a refrigeration cycle of the refrigerant circuit 11 and supplies the gas refrigerant to the scroll compression mechanism 481 is provided to penetrate the upper lid 480b. The lower end of the suction pipe 419 is connected to the fixed scroll 482 of the scroll compression mechanism 481. The suction pipe 419 communicates with a compression chamber Sc of the scroll compression mechanism 481 described later. A discharge pipe 418 through which the refrigerant discharged to the outside of the casing 480 passes is provided in an intermediate portion of the cylindrical member 480a of the casing 480. The discharge pipe 418 is arranged such that an end portion of the discharge pipe 418 inside the casing 480 protrudes into a high-pressure space Sh formed below a housing 488 of the scroll compression mechanism 481. A high-pressure refrigerant in the refrigeration cycle after being compressed by the scroll compression mechanism 481 flows through the discharge pipe 418.

The scroll compression mechanism 481 mainly includes the housing 488, the fixed scroll 482 arranged above the housing 488, and a movable scroll 484 combined with the fixed scroll 482 to form the compression chamber Sc.

The fixed scroll 482 includes a flat plate-shaped fixed-side end plate 482a, a spiral fixed-side wrap 482b protruding from the front surface of the fixed-side end plate 482a, and an outer edge portion 482c surrounding the fixed-side wrap 482b. A non-circular discharge port 482d communicating with the compression chamber Sc of the scroll compression mechanism 481 is formed at the central portion of the fixed-side end plate 482a so as to penetrate the fixed-side end plate 482a in the thickness direction. The refrigerant compressed in the compression chamber Sc is discharged from the discharge port 482d, passes through a refrigerant passage (not shown) formed in the fixed scroll 482 and the housing 488, and flows into the high-pressure space Sh.

The movable scroll 484 includes a flat plate-shaped movable-side end plate 484a, a spiral movable-side wrap 484b protruding from the front surface of the movable-side end plate 484a, and a boss portion 484c protruding from the back surface of the movable-side end plate 484a and formed in a cylindrical shape. The fixed-side wrap 482b of the fixed scroll 482 and the movable-side wrap 484b of the movable scroll 484 are combined in a state where the lower surface of the fixed-side end plate 482a and the upper surface of the movable-side end plate 484a face each other. The compression chamber Sc is formed between the adjacent fixed-side wrap 482b and movable-side wrap 484b. When the movable scroll 484 revolves with respect to the fixed scroll 482 as described later, the volume of the compression chamber Sc periodically changes, and the scroll compression mechanism 481 sucks, compresses, and discharges the refrigerant. The boss portion 484c is a cylindrical portion whose upper end is closed. An eccentric portion 495 of the crankshaft 494 described later and a cylindrical slider 475 attached to the eccentric portion 495 are inserted into a hollow portion of the boss portion 484c, whereby the movable scroll 484 and the crankshaft 494 are coupled. The boss portion 484c is arranged in an eccentric portion space 489 formed between the movable scroll 484 and the housing 488. The eccentric portion space 489 communicates with the high-pressure space Sh via an oil supply path 497 or the like of the crankshaft 494 described later, and a high pressure acts on the eccentric portion space 489. This pressure pushes the lower surface of the movable-side end plate 484a in the eccentric portion space 489 upward toward the fixed scroll 482. This force brings the movable scroll 484 into close contact with the fixed scroll 482. The movable scroll 484 is supported by the housing 488 through an Oldham ring 499 arranged in an “Oldham ring space Sr”. The Oldham ring 499 is a member that prevents rotation of the movable scroll 484 and revolves the movable scroll 484. By using the Oldham ring 499, when the crankshaft 494 rotates, the movable scroll 484 coupled to the crankshaft 494 in the boss portion 484c revolves without rotating with respect to the fixed scroll 482, and the refrigerant in the compression chamber Sc is compressed.

The housing 488 is press-fitted into the cylindrical member 480a, and is fixed to the cylindrical member 480a over the entire circumferential direction on the outer peripheral surface thereof. The housing 488 and the fixed scroll 482 are fixed with bolts or the like (not shown) such that the upper end surface of the housing 488 is in close contact with the lower surface of the outer edge portion 482c of the fixed scroll 482. The housing 488 is formed with a concave portion 488a arranged so as to be recessed in the central portion of the upper surface and a bearing portion 488b arranged below the concave portion 488a. The concave portion 488a surrounds a side surface of the eccentric portion space 489 in which the boss portion 484c of the movable scroll 484 is arranged. The bearing portion 488b is provided with a bearing 490 that pivotally supports a main shaft 496 of the crankshaft 494. A tubular sleeve 470 is inserted into a portion of the main shaft 496 covered with the bearing 490 from the periphery. The bearing 490 rotatably supports the main shaft 496 whose periphery is covered with the sleeve 470. An Oldham ring space Sr in which the Oldham ring 499 is arranged is formed in the housing 488.

The drive motor 491 includes an annular stator 492 fixed to an inner wall surface of the cylindrical member 480a, and a rotor 493 rotatably accommodated inside the stator 492 with a slight gap (air gap passage). The stator 492 has a coil. The rotor 493 is coupled to the movable scroll 484 via the crankshaft 494 arranged to extend in the vertical direction along the axial center of the cylindrical member 480a. When the rotor 493 rotates, the movable scroll 484 revolves with respect to the fixed scroll 482.

The crankshaft 494 transmits a driving force of the drive motor 491 to the movable scroll 484. The crankshaft 494 is arranged so as to extend in the vertical direction along the axial center of the cylindrical member 480a, and couples the rotor 493 of the drive motor 491 and the movable scroll 484 of the scroll compression mechanism 481. The crankshaft 494 includes the main shaft 496 whose center axis coincides with the axial center of the cylindrical member 480a, and the eccentric portion 495 eccentric to the axial center of the cylindrical member 480a. As described above, the slider 475 is inserted into the eccentric portion 495, and the eccentric portion 495 is inserted into the boss portion 484c of the movable scroll 484 together with the slider 475. The main shaft 496 is rotatably supported by the bearing 490 of the bearing portion 488b of the housing 488 and the lower bearing 498 described later. The main shaft 496 is coupled to the rotor 493 of the drive motor 491 between the bearing portion 488b and the lower bearing 498. The oil supply path 497 for supplying the refrigerating machine oil O to the scroll compression mechanism 481 and the like is formed inside the crankshaft 494. The lower end of the main shaft 496 is located in the oil reservoir space So formed in the lower portion of the casing 480, and the refrigerating machine oil O in the oil reservoir space So is supplied to the scroll compression mechanism 481 and the like through the oil supply path 497.

The balance weight 485 is a separate member from the crankshaft 494, has an annular shape, and is fitted into the main shaft 496. The balance weight 485 includes a cylindrical portion 485a and an eccentric portion 485b formed on a part of the cylindrical portion 485a in the circumferential direction. The center of gravity of the cylindrical portion 485a is on the axial center of the crankshaft 494 and has a circular shape as viewed in the axial direction. The center of gravity of the eccentric portion 485b is eccentric from the axial center of the crankshaft 494, specifically, is eccentric from the axial center of the crankshaft 494 in a predetermined direction. As a result, the center of gravity of the entire balance weight 485 is also eccentric in the predetermined direction from the axial center of the crankshaft 494. As described above, the vicinity of the center of the movable scroll 484 is slidably supported by the eccentric portion 495 of the crankshaft 494 and the slider 475. Accordingly, the movable scroll 484 is also eccentric in the same direction as the eccentric portion 495. With the above structure, the balance weight 485 is disposed on the main shaft 496 such that the predetermined direction is opposite to the eccentric direction of the eccentric portion 495. Accordingly, balance with the movable scroll 484 is achievable, wherefore oscillation of the crankshaft 494 is prevented.

The lower bearing 498 is arranged below the drive motor 491. The lower bearing 498 is fixed to the cylindrical member 480a. The lower bearing 498 constitutes a bearing on the lower end side of the crankshaft 494, and rotatably supports the main shaft 496 of the crankshaft 494.

In the above compressor 41, in particular, at least one of the movable scroll 484, the fixed scroll 482, the Oldham ring 499, and the crankshaft 494 is made of metal other than aluminum or an aluminum alloy, or is made of metal in which the content of aluminum is equal to or less than the ratio at which corrosion of aluminum occurs by iodine. Examples of the metal other than aluminum or an aluminum alloy include copper, a copper alloy, iron, an alloy containing iron, and stainless steel.

The movable scroll 484 and the crankshaft 494 may be coupled via a slider for revolving the movable scroll 484. In addition, a slider may be provided at a position surrounded by the housing 488 in the crankshaft 494.

Next, the operation of the compressor 41 will be described.

When the drive motor 491 is started, the rotor 493 rotates with respect to the stator 492, and the crankshaft 494 fixed to the rotor 493 rotates. When the crankshaft 494 rotates, the movable scroll 484 coupled to the crankshaft 494 revolves with respect to the fixed scroll 482. Then, the low-pressure gas refrigerant in the refrigeration cycle passes through the suction pipe 419 and is sucked into the compression chamber Sc from the peripheral edge side of the compression chamber Sc. As the movable scroll 484 revolves, the suction pipe 419 and the compression chamber Sc do not communicate with each other. Then, as the volume of the compression chamber Sc decreases, the pressure of the compression chamber Sc starts to increase.

The refrigerant in the compression chamber Sc is compressed as the volume of the compression chamber Sc decreases, and finally becomes a high-pressure gas refrigerant. The high-pressure gas refrigerant is discharged from the discharge port 482d located near the center of the fixed-side end plate 482a. Thereafter, the high-pressure gas refrigerant passes through a refrigerant passage (not shown) formed in the fixed scroll 482 and the housing 488, and flows into the high-pressure space Sh. The high-pressure gas refrigerant flowing into the high-pressure space Sh and compressed by the scroll compression mechanism 481 in the refrigeration cycle is discharged from the discharge pipe 418.

### (1-3-3) Configuration in Utilization-Side Space SP2

In the utilization-side space SP2, an expansion valve 44, a utilization-side heat exchanger 45, and a utilization-side fan 48 are arranged. For the utilization-side fan 48, for example, a centrifugal fan is used. Examples of the centrifugal fan include, for example, a sirocco fan. Note that the expansion valve 44 may be arranged in the heat-source-side space SP1. The expansion valve 44 is a known expansion valve used in a refrigerant circuit (not shown), and includes a valve body, a valve seat having an opening through which a size of a refrigerant flow path is adjusted by the valve body, and a coil for moving the valve body by a magnetic force. Here, at least one of the valve body, the valve seat, and the coil is made of metal other than aluminum or an aluminum alloy, or is made of metal in which the content of aluminum is equal to or less than the ratio at which corrosion of aluminum occurs by iodine. Examples of the metal other than aluminum or an aluminum alloy include copper, a copper alloy, iron, an alloy containing iron, and stainless steel.

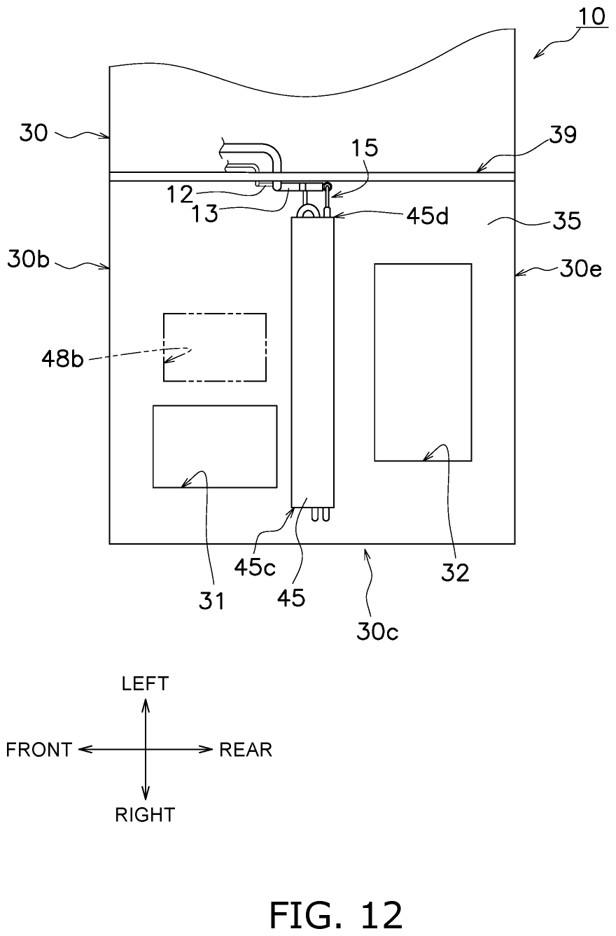

As shown in FIG. 5, the utilization-side fan 48 is arranged above the first opening 31 by a support stand 51. As shown in FIG. 12, a blow-out port 48b of the utilization-side fan 48 is arranged at a position that does not overlap with the first opening 31 in top view. Since the support stand 51 and the casing 30 surround a portion other than the blow-out port 48b and the first opening 31 of the utilization-side fan 48, substantially all of air blown out from the blow-out port 48b of the utilization-side fan 48 is supplied into a room from the first opening 31 through the duct 21.

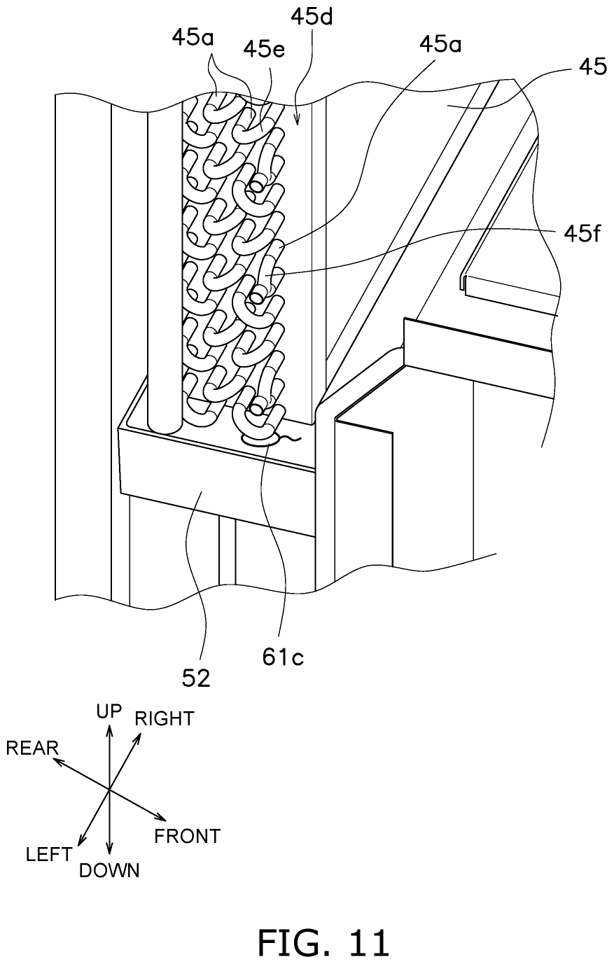

The utilization-side heat exchanger 45 includes a plurality of heat transfer tubes 45a (see FIG. 11) through which a refrigerant flows, and a plurality of heat transfer fins (not shown) in which air flows through gaps between with each other. The plurality of heat transfer tubes 45a are arranged aligned in an up-down direction (a row direction), and each heat transfer tube 45a extends in a direction (in the first embodiment, a left-right direction) substantially orthogonal to the up-down direction. Here, the refrigerant flows in the left-right direction in the plurality of heat transfer tubes 45a. Further, the plurality of heat transfer tubes 45a are provided in a plurality of rows in a front-rear direction. At an end portion of the utilization-side heat exchanger 45, for example, the heat transfer tubes 45a are bent in a U shape or connected to each other by a U-shaped tube such that a flow of the refrigerant is folded back from one column to another column and/or from one row to another row. The plurality of heat transfer fins extending long in the up-down direction are arranged along an extending direction of the heat transfer tubes 45a at a predetermined distance from each other. Then, the plurality of heat transfer fins and the plurality of heat transfer tubes 45a are combined such that the plurality of heat transfer tubes 45a penetrate individual heat transfer fins. For example, aluminum can be used for the heat transfer fins constituting the utilization-side heat exchanger 45. Here, the heat transfer tubes 45a constituting the utilization-side heat exchanger 45 are made of metal other than aluminum or an aluminum alloy, or are made of metal in which the content of aluminum is equal to or less than the ratio at which corrosion of aluminum occurs by iodine. Examples of the metal other than aluminum or an aluminum alloy include copper, a copper alloy, iron, an alloy containing iron, and stainless steel.

The utilization-side heat exchanger 45 has a shape that is short in the front-rear direction and long in the up-down and left-right directions. A drain pan 52 has such a shape obtained by removing a top surface of a rectangular parallelepiped extending long to the left and right. The drain pan 52 has a dimension, in the front-rear direction, that is longer than a length in the front-rear direction of the utilization-side heat exchanger 45 in top view. The utilization-side heat exchanger 45 is fitted in such a drain pan 52. Then, the drain pan 52 receives dew condensation water generated in the utilization-side heat exchanger 45 and dripping downward. The drain pan 52 extends from the right side surface 30c to the partition plate 39 in the casing 30. A drain port 52a of the drain pan 52 penetrates the right side surface 30c of the casing 30, and the dew condensation water received by the drain pan 52 is drained to the outside of the casing 30 through the drain port 52a.

Further, the utilization-side heat exchanger 45 extends from a vicinity of the right side surface 30c of the casing 30 to a vicinity of the partition plate 39. A metal plate closes a space between the right side surface 30c of the casing 30 and a right side portion 45c of the utilization-side heat exchanger 45, and a space between the partition plate 39 and a left side portion 45d of the utilization-side heat exchanger 45. The drain pan 52 is supported by a support frame 36 at a position of a height hl with the bottom plate 35 as a reference, away from the bottom plate 35 upward. The support of the utilization-side heat exchanger 45 includes a rod-shaped frame member that is adapted to a periphery of the top, bottom, left, and right of the utilization-side heat exchanger 45, and is assisted by an auxiliary frame 53 that is directly or indirectly fixed to the casing 30 and the partition plate 39. A space between the utilization-side heat exchanger 45 and the top surface 30a of the casing 30 is closed by the utilization-side heat exchanger 45 itself or the auxiliary frame 53. Further, an opening between the utilization-side heat exchanger 45 and the bottom plate 35 is closed by the support stand 51 and the drain pan 52.

In this way, the utilization-side heat exchanger 45 divides the utilization-side space SP2 into a space on an upstream side of the utilization-side heat exchanger 45 and a space on a downstream side of the utilization-side heat exchanger 45. Then, all the air flowing from the upstream side to the downstream side of the utilization-side heat exchanger 45 passes through the utilization-side heat exchanger 45. The utilization-side fan 48 is arranged in the space on the downstream side of the utilization-side heat exchanger 45, and generates an airflow that passes through the utilization-side heat exchanger 45. The support stand 51 described above further divides the space on the downstream side of the utilization-side heat exchanger 45 into a space on the suction side and a space on the blow-out side of the utilization-side fan 48.

(1-3-4) Refrigerant circuit

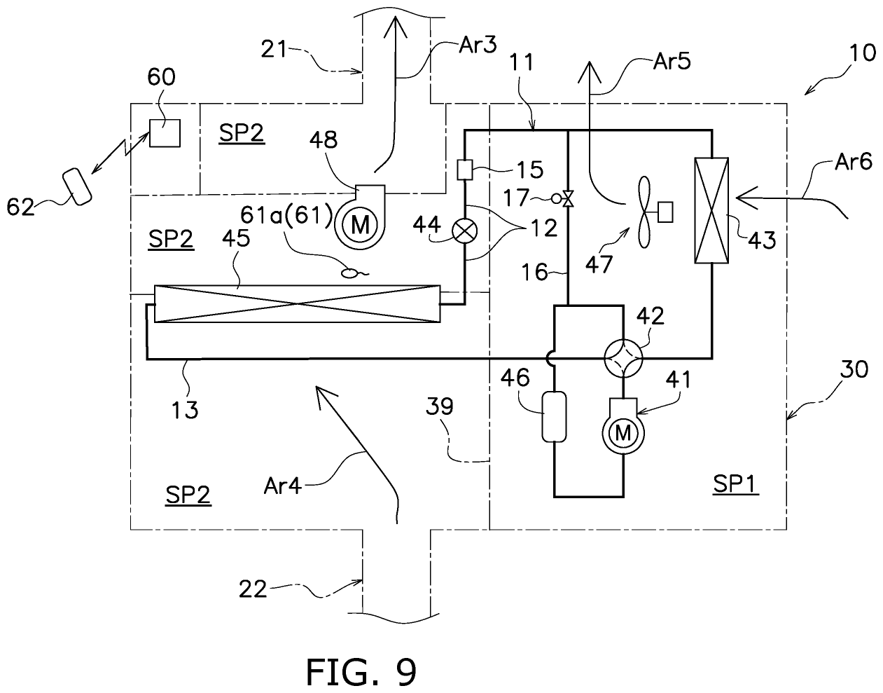

FIG. 9 shows a refrigerant circuit 11 configured in the air conditioner 10. The refrigerant circuit 11 includes the utilization-side heat exchanger 45 and the heat-source-side heat exchanger 43. In the refrigerant circuit 11, a refrigerant circulates between the utilization-side heat exchanger 45 and the heat-source-side heat exchanger 43.

In this refrigerant circuit 11, when a vapor compression refrigeration cycle is being performed in a cooling operation or a heating operation, heat is exchanged between the utilization-side heat exchanger 45 and the heat-source-side heat exchanger 43. In FIG. 9, an arrow Ar3 indicates supply air, which is an airflow on the downstream side of the utilization-side heat exchanger 45 and blown out from the utilization-side fan 48, while an arrow Ar4 indicates return air, which is an airflow on the upstream side of the utilization-side heat exchanger 45. Further, an arrow Ar5 indicates an airflow blown out from the third opening 33 by the heat-source-side fan 47, which is an airflow on a downstream side of the heat-source-side heat exchanger 43, while an arrow Ar6 indicates an airflow suctioned from the slit 34 by the heat-source-side fan 47, which is an airflow on an upstream side of the heat-source-side heat exchanger 43.

The refrigerant circuit 11 includes the compressor 41, the four-way valve 42, the heat-source-side heat exchanger 43, the expansion valve 44, the utilization-side heat exchanger 45, the accumulator 46, a drier 15, a bypass flow path 16, and an on-off valve 17. The bypass flow path 16 connects between the heat-source-side heat exchanger 43 and the expansion valve 44 and between the four-way valve 42 and the accumulator 46. The on-off valve 17 is a control valve that is controlled to switch between an open state and a closed state, and is provided in the bypass flow path 16. The on-off valve 17 guides part of the refrigerant flowing between the heat-source-side heat exchanger 43 and the expansion valve 44 to a portion between the four-way valve 42 and the accumulator 46 while being controlled to be in the open state. The drier 15 is provided between the heat-source-side heat exchanger 43 and the expansion valve 44, and reduces the moisture concentration in the fluid including the refrigerant and the refrigerating machine oil flowing through the refrigerant circuit 11. Such a drier 15 is made of metal other than aluminum or an aluminum alloy, or is made of metal in which the content of aluminum is equal to or less than the ratio at which corrosion of aluminum occurs by iodine. Examples of the metal other than aluminum or an aluminum alloy include copper, a copper alloy, iron, an alloy containing iron, and stainless steel.

The four-way valve 42 switches to a connection state shown by a solid line during a cooling operation, and switches to a connection state shown by a broken line during a heating operation.

During the cooling operation, a gas refrigerant compressed by the compressor 41 is sent to the heat-source-side heat exchanger 43 through the four-way valve 42. This refrigerant radiates heat to outdoor air with the heat-source-side heat exchanger 43, and is sent to the expansion valve 44 through a refrigerant pipe 12. In the expansion valve 44, the refrigerant expands to be decompressed, and is sent to the utilization-side heat exchanger 45 through the refrigerant pipe 12. The low-temperature and low-pressure refrigerant sent from the expansion valve 44 exchanges heat in the utilization-side heat exchanger 45 to take heat from indoor air. The air removed of heat and cooled by the utilization-side heat exchanger 45 is supplied to the room 18 through the duct 21. A gas refrigerant or a gas-liquid two-phase refrigerant that has exchanged heat in the utilization-side heat exchanger 45 is suctioned into the compressor 41 through a refrigerant pipe 13, the four-way valve 42, and the accumulator 46.

During the heating operation, a gas refrigerant compressed by the compressor 41 is sent to the utilization-side heat exchanger 45 through the four-way valve 42 and the refrigerant pipe. This refrigerant exchanges heat with indoor air in the utilization-side heat exchanger 45 to give heat to the indoor air. The air given with heat and heated by the utilization-side heat exchanger 45 is supplied to the room 18 through the duct 21. The refrigerant that has exchanged heat in the utilization-side heat exchanger 45 is sent to the expansion valve 44 through the refrigerant pipe 12. The low-temperature low-pressure refrigerant expanded by the expansion valve 44 to be decompressed is sent to the heat-source-side heat exchanger 43 through the refrigerant pipe 12, and exchanges heat by the heat-source-side heat exchanger 43 to obtain heat from the outdoor air. A gas refrigerant or a gas-liquid two-phase refrigerant that has exchanged heat in the heat-source-side heat exchanger 43 is suctioned into the compressor 41 through the four-way valve 42 and the accumulator 46.

### (1-3-5) Control System

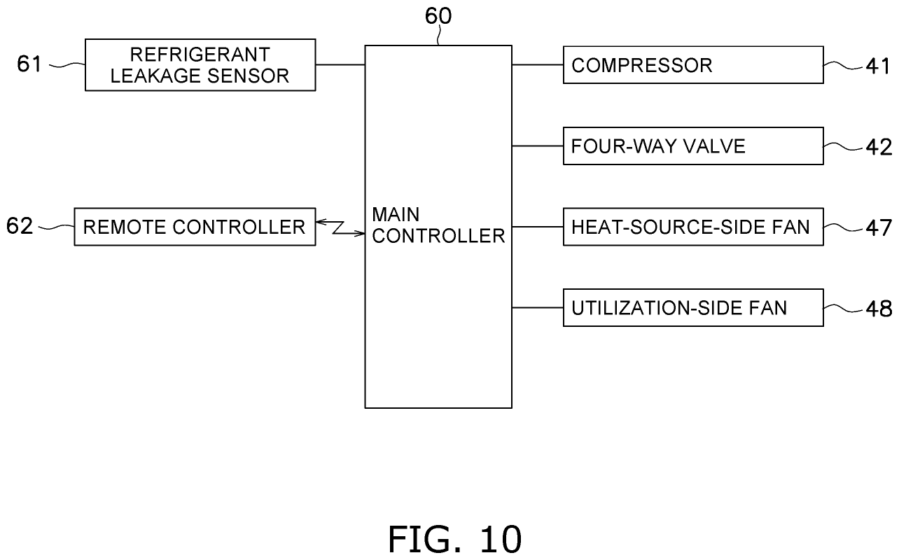

FIG. 10 shows a main controller 60 that controls the air conditioner 10, main equipment controlled by the main controller 60, and the like. The main controller 60 controls the compressor 41, the four-way valve 42, the heat-source-side fan 47, and the utilization-side fan 48. The main controller 60 is configured to communicate with a remote controller 62. A user can transmit a set value of an indoor temperature of the room 18, and the like, from the remote controller 62 to the main controller 60.

For the control of the air conditioner 10, there are provided a plurality of temperature sensors to measure a refrigerant temperature of each part of the refrigerant circuit 11 and/or pressure sensors to measure a pressure of each part, and temperature sensors to measure an air temperature of each part.

The main controller 60 controls at least on and off of the compressor 41, on and off of the heat-source-side fan 47, and on and off of the utilization-side fan 48. Note that, in a case where any or all of the compressor 41, the heat-source-side fan 47, and the utilization-side fan 48 have a type of motor that can change a number of revolutions, the main controller 60 may be configured to control a number of revolutions of a motor with variable number of revolutions among the compressor 41, the heat-source-side fan 47, and the utilization-side fan 48. In that case, the main controller 60 can change a circulation amount of a refrigerant flowing through the refrigerant circuit 11, by changing a number of revolutions of a motor of the compressor 41. By changing a number of revolutions of a motor of the heat-source-side fan 47, the main controller 60 can change a flow rate of outdoor air flowing between the heat transfer fins of the heat-source-side heat exchanger 43. Further, by changing a number of revolutions of a motor of the utilization-side fan 48, the main controller 60 can change a flow rate of indoor air flowing between the heat transfer fins of the utilization-side heat exchanger 45.

The main controller 60 is connected with the refrigerant leakage sensor 61. When refrigerant gas leaked into air reaches equal to or more than a detection lower limit concentration, the refrigerant leakage sensor 61 transmits a signal indicating detection of refrigerant gas leakage to the main controller 60.

The main controller 60 is realized by, for example, a computer. The computer constituting the main controller 60 includes a control arithmetic device and a storage device. A processor such as a CPU or a GPU can be used as the control arithmetic device. The control arithmetic device reads a program stored in the storage device and performs predetermined image processing and arithmetic processing in accordance with the program. Further, the control arithmetic device can write an arithmetic result to the storage device and read information stored in the storage device in accordance with the program. Alternatively, the main controller 60 may be configured using an integrated circuit (IC) capable of performing control similar to that performed using the CPU and memory. Examples of the IC mentioned herein include a large-scale integrated circuit (LSI), an application-specific integrated circuit (ASIC), a gate array, a field programmable gate array (FPGA), and the like.

### (1-4) Characteristics of First Embodiment

In the first embodiment, even when a mixed refrigerant containing CF₃I or CF₃I or a refrigerant containing iodine, such as R466A, is used, it is possible to suppress corrosion of aluminum or an aluminum alloy caused by iodine by refraining from adopting aluminum or an aluminum alloy at a portion that is in contact with the refrigerant.

Specifically, by refraining from adopting aluminum or an aluminum alloy in the movable scroll 484, the fixed scroll 482, the Oldham ring 499, the slider, the sleeve, and the crankshaft 494 in the compressor 41, the valve body and the coil of the expansion valve 44, the heat transfer tubes of the heat-source-side heat exchanger 43, the heat transfer tubes 45a of the utilization-side heat exchanger 45, the drier 15, and the like, it is possible to suppress corrosion of these members.

### (1-5) Modification of First Embodiment

In the first embodiment, the description has been given by exemplifying the case where the scroll compressor is employed as the compressor 41.

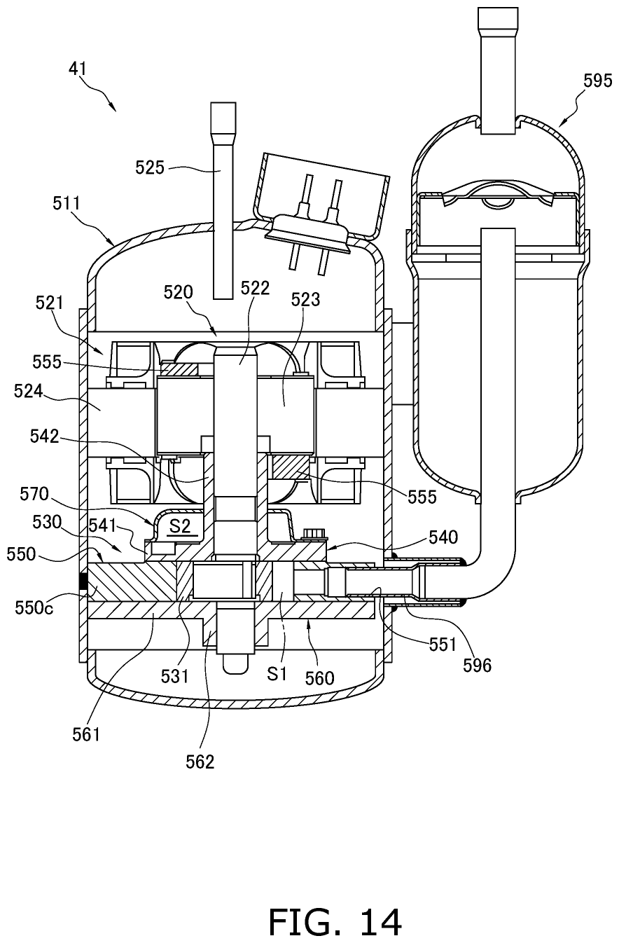

On the other hand, the compressor 41 is not limited to the scroll compressor, and a rotary compressor shown in FIGS. 14, 15, and 16 may be used.

As shown in FIG. 14, the compressor 41 is a one-cylinder type rotary compressor, and includes a casing 511, and a drive mechanism 520 and a compression mechanism 530 arranged in the casing 511. In the compressor 41, the compression mechanism 530 is arranged below the drive mechanism 520 in the casing 511.

### (1-5-1) Drive Mechanism

The drive mechanism 520 is accommodated in an upper portion of the internal space of the casing 511 and drives the compression mechanism 530. The drive mechanism 520 includes a motor 521 serving as a drive source, a crankshaft 522 serving as a drive shaft attached to the motor 521, and balance weights 555.

The motor 521 is a motor for rotationally driving the crankshaft 522, and mainly includes a rotor 523 and a stator 524. The crankshaft 522 is inserted and fitted into the internal space of the rotor 523, and rotates together with the crankshaft 522. The rotor 523 includes laminated electromagnetic steel plates and magnets embedded in a rotor body. The stator 524 is arranged on the radially outer side of the rotor 523 with a predetermined space interposed therebetween. The stator 524 includes laminated electromagnetic steel plates and a coil wound around a stator body. The motor 521 rotates the rotor 523 together with the crankshaft 522 by an electromagnetic force generated in the stator 524 by applying a current to the coil.

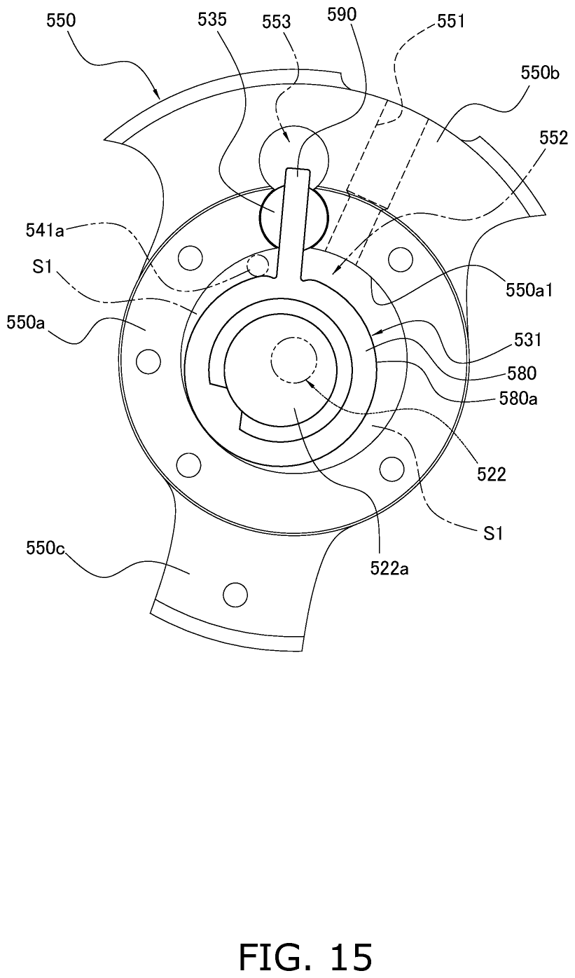

The crankshaft 522 is inserted and fitted into the rotor 523 and rotates about a rotation axis. As shown in FIG. 15, a crank pin 522a which is an eccentric portion of the crankshaft 522 is inserted into a roller 580 (described later) of a piston 531 of the compression mechanism 530, and is fitted into a roller 580 in a state where a rotational force from the rotor 523 can be transmitted. The crankshaft 522 rotates according to the rotation of the rotor 523, eccentrically rotates the crank pin 522a, and revolves the roller 580 of the piston 531 of the compression mechanism 530. That is, the crankshaft 522 has a function of transmitting a driving force of the motor 521 to the compression mechanism 530.

The balance weights 555 are provided via end links in upper and lower portions of the rotor 523 in order to correct an imbalance due to a centrifugal force generated at the crank pin 522a that is an eccentric portion when the crankshaft 522 is rotationally driven.

### (1-5-2) Compression Mechanism

The compression mechanism 530 is accommodated on the lower side in the casing 511. The compression mechanism 530 compresses the refrigerant sucked through a suction pipe 596. The compression mechanism 530 is a rotary compression mechanism, and mainly includes a front head 540, a cylinder 550, the piston 531, and a rear head 560. The refrigerant compressed in a compression chamber S1 of the compression mechanism 530 is discharged from a front head discharge hole 541a formed in a front head 540 to a space where the motor 521 is arranged and a lower end of a discharge pipe 525 is located through a muffler space S2 surrounded by the front head 540 and a muffler 570.

### (1-5-2-1) Cylinder

The cylinder 550 is a cast member made of metal. The cylinder 550 includes a cylindrical central portion 550a, a first outer extending portion 550b extending from the central portion 550a to the side of an auxiliary accumulator 595, and a second outer extending portion 550c extending from the central portion 550a to the side opposite to the first outer extending portion 550b. A suction hole 551 for sucking a low-pressure refrigerant in the refrigeration cycle is formed in the first outer extending portion 550b. A columnar space inside an inner peripheral surface 550a1 of the central portion 550a becomes a cylinder chamber 552 into which the refrigerant sucked from the suction hole 551 flows. The suction hole 551 extends from the cylinder chamber 552 toward the outer peripheral surface of the first outer extending portion 550b, and is opened on the outer peripheral surface of the first outer extending portion 550b. A distal end portion of the suction pipe 596 extending from the accumulator 595 is inserted into the suction hole 551. The cylinder chamber 552 accommodates the piston 531 and the like for compressing the refrigerant flowing into the cylinder chamber 552.

In the cylinder chamber 552 formed by the cylindrical central portion 550a of the cylinder 550, a first end which is a lower end thereof is opened, and a second end which is an upper end thereof is also opened. The first end which is the lower end of the central portion 550a is closed by the rear head 560 described later. The second end which is the upper end of the central portion 550a is closed by the front head 540 described later.

A blade swing space 553 in which a bush 535 and a blade 590 described later are arranged is formed in the cylinder 550. The blade swing space 553 is formed across the central portion 550a and the first outer extending portion 550b, and the blade 590 of the piston 531 is swingably supported by the cylinder 550 via the bush 535. The blade swing space 553 is formed so as to extend from the cylinder chamber 552 toward the outer peripheral side in the vicinity of the suction hole 551 in plan view.

### (1-5-2-2) Front Head

As shown in FIG. 14, the front head 540 includes a front head disk portion 541 that closes the opening at the second end that is the upper end of the cylinder 550, and a front head boss portion 542 that extends upward from the peripheral edge of the front head opening at the center of the front head disk portion 541. The front head boss portion 542 has a cylindrical shape and functions as a bearing of the crankshaft 522.

The front head disk portion 541 has the front head discharge hole 541a formed at a planar position shown in FIG. 15. From the front head discharge hole 541a, the refrigerant compressed in the compression chamber Si whose volume changes in the cylinder chamber 552 of the cylinder 550 is intermittently discharged. The front head disk portion 541 is provided with a discharge valve that opens and closes an outlet of the front head discharge hole 541a. This discharge valve is opened by a pressure difference when the pressure in the compression chamber S1 becomes higher than the pressure in the muffler space S2, and causes the refrigerant to be discharged from the front head discharge hole 541a into the muffler space S2.

### (1-5-2-3) Muffler

As shown in FIG. 14, the muffler 570 is attached to an upper surface of a peripheral edge portion of the front head disk portion 541 of the front head 540. The muffler 570 forms the muffler space S2 together with the upper surface of the front head disk portion 541 and the outer peripheral surface of the front head boss portion 542 to reduce noise accompanying discharge of the refrigerant. As described above, the muffler space S2 and the compression chamber Si communicate with each other through the front head discharge hole 541a when the discharge valve is opened.

In addition, the muffler 570 is formed with a central muffler opening through which the front head boss portion 542 penetrates, and a muffler discharge hole through which the refrigerant flows from the muffler space S2 to an accommodation space of the upper motor 521.

The muffler space S2, the accommodation space of the motor 521, the space above the motor 521 where the discharge pipe 525 is located, the space where the lubricating oil is accumulated below the compression mechanism 530, and the like are all connected to form a high-pressure space having equal pressure.

### (1-5-2-4) Rear Head

The rear head 560 includes a rear head disk portion 561 that closes the opening at the first end which is the lower end of the cylinder 550, and a rear head boss portion 562 as a bearing extending downward from a peripheral edge portion of a central opening of the rear head disk portion 561. The front head disk portion 541, the rear head disk portion 561, and the central portion 550a of the cylinder 550 form a cylinder chamber 552 as shown in FIG. 15.

The front head boss portion 542 and the rear head boss portion 562 are cylindrical boss portions and pivotally support the crankshaft 522.

### (1-5-2-5) Piston

The piston 531 is arranged in the cylinder chamber 552 and is attached to the crank pin 522a which is the eccentric portion of the crankshaft 522. The piston 531 is a member in which the roller 580 and the blade 590 are integrated. The blade 590 of the piston 531 is arranged in the blade swing space 553 formed in the cylinder 550, and is swingably supported by the cylinder 550 via the bush 535 as described above. In addition, the blade 590 is slidable on the bush 535, and repeatedly moves away from the crankshaft 522 and close to the crankshaft 522 while swinging during operation.

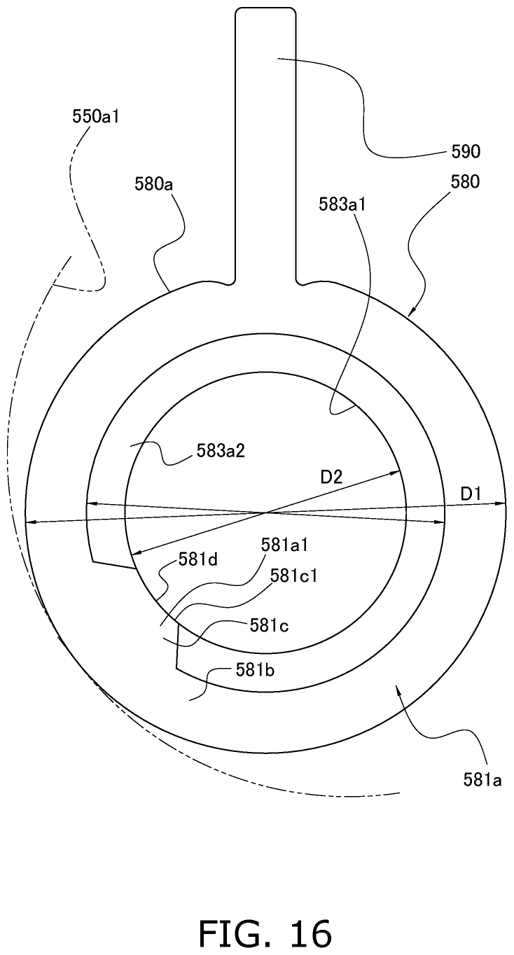

The roller 580 includes a first end portion 581 where a first end surface 581a as a roller lower end surface is formed, a second end portion 582 where a second end surface 582a as a roller upper end surface is formed, and a central portion 583 located between the first end portion 581 and the second end portion 582. As shown in FIG. 16, the central portion 583 is a cylindrical portion having an inner diameter D2 and an outer diameter D1. The first end portion 581 includes a cylindrical first body portion 581b having an inner diameter D3 and the outer diameter D1, and a first protruding portion 581c protruding inward from the first body portion 581b. The outer diameter D1 of the first body portion 581b is the same dimension as the outer diameter D1 of the central portion 583. The inner diameter D3 of the first body portion 581b is larger than the inner diameter D2 of the central portion 583. The second end portion 582 includes a cylindrical second body portion 582b having the inner diameter D3 and the outer diameter D1, and a second protruding portion 582c protruding inward from the second body portion 582b. The outer diameter D1 of the second body portion 582b is the same dimension as the outer diameter D1 of the central portion 583, similarly to the outer diameter D1 of the first body portion 581b. In addition, the inner diameter D3 of the second body portion 582b is the same dimension as the inner diameter D3 of the first body portion 581b, and is larger than the inner diameter D2 of the central portion 583. An inner surface 581c1 of the first protruding portion 581c and an inner surface 582c1 of the second protruding portion 582c substantially overlap an inner peripheral surface 583a1 of the central portion 583 as viewed in the rotation axis direction of the crankshaft 522. Specifically, the inner surface 581c1 of the first protruding portion 581c and the inner surface 582c1 of the second protruding portion 582c are located slightly outside the inner peripheral surface 583a1 of the central portion 583 in plan view. As described above, except for the first protruding portion 581c and the second protruding portion 582c, the inner diameter D3 of the first body portion 581b and the second body portion 582b is larger than the inner diameter D2 of the central portion 583. Therefore, a first step surface 583a2 is formed at the height position of the boundary between the first end portion 581 and the central portion 583, and a second step surface 583a3 is formed at the height position of the boundary between the second end portion 582 and the central portion 583 (see FIG. 16).

The annular first end surface 581a of the first end portion 581 of the roller 580 is in contact with the upper surface of the rear head disk portion 561 and slides on the upper surface of the rear head disk portion 561. The first end surface 581a of the roller 580 includes a first wide surface 581a1 having a partially increased radial width. The first protruding portion 581c of the first end portion 581 and a part of the first body portion 581b of the first end portion 581 located on the outside thereof form the first wide surface 581a1 (see FIG. 16).

The annular second end surface 582a of the second end portion 582 of the roller 580 is in contact with the lower surface of the front head disk portion 541 and slides on the lower surface of the front head disk portion 541. The second end surface 582a of the roller 580 includes a second wide surface 582a1 having a partially increased radial width. The second wide surface 582a1 is located at the same position as the first wide surface 581a1 as viewed in the rotation axis direction of the crankshaft 522. The second protruding portion 582c of the second end portion 582 and a part of the second body portion 582b of the second end portion 582 located on the outside thereof form the second wide surface 582a1.

As shown in FIG. 15, the roller 580 and the blade 590 of the piston 531 form the compression chamber S1 whose volume changes due to the revolution of the piston 531 so as to partition the cylinder chamber 552. The compression chamber S1 is a space surrounded by the inner peripheral surface 550a1 of the central portion 550a of the cylinder 550, the upper surface of the rear head disk portion 561, the lower surface of the front head disk portion 541, and the piston 531. The volume of the compression chamber Si changes according to the revolution of the piston 531, and the low-pressure refrigerant sucked from the suction hole 551 is compressed into a high-pressure refrigerant, and is discharged from the front head discharge hole 541a to the muffler space S2.

### (1-5-3) Operation

In the above compressor 41, the volume of the compression chamber S1 is changed by the movement of the piston 531 of the compression mechanism 530 that revolves due to the eccentric rotation of the crank pin 522a. Specifically, first, while the piston 531 revolves, the low-pressure refrigerant is sucked into the compression chamber S1 from the suction hole 551. At the time when the refrigerant is sucked, the volume of the compression chamber Si facing the suction hole 551 gradually increases. When the piston 531 further revolves, the communicating state between the compression chamber S1 and the suction hole 551 is released, and the refrigerant compression in the compression chamber S1 starts. Thereafter, the volume of the compression chamber S1 communicating with the front head discharge hole 541a becomes considerably small, and the pressure of the refrigerant also becomes high. Thereafter, as the piston 531 further revolves, the high-pressure refrigerant pushes open the discharge valve from the front head discharge hole 541a and is discharged into the muffler space S2. The refrigerant introduced into the muffler space S2 is discharged from the muffler discharge hole of the muffler 570 to a space above the muffler space S2. The refrigerant discharged to the outside of the muffler space S2 passes through a space between the rotor 523 and the stator 524 of the motor 521, cools the motor 521, and is then discharged from the discharge pipe 525.

In the above scroll compressor, at least one of the piston 531, the cylinder 550, and the crankshaft 522 is made of metal other than aluminum or an aluminum alloy, or is made of metal in which the content of aluminum is equal to or less than the ratio at which corrosion of aluminum occurs by iodine.

Even in this case, it is possible to suppress corrosion of these components constituting the scroll compressor due to iodine.

### (2) Second Embodiment

(2-1) Configuration of Air Conditioning system 1

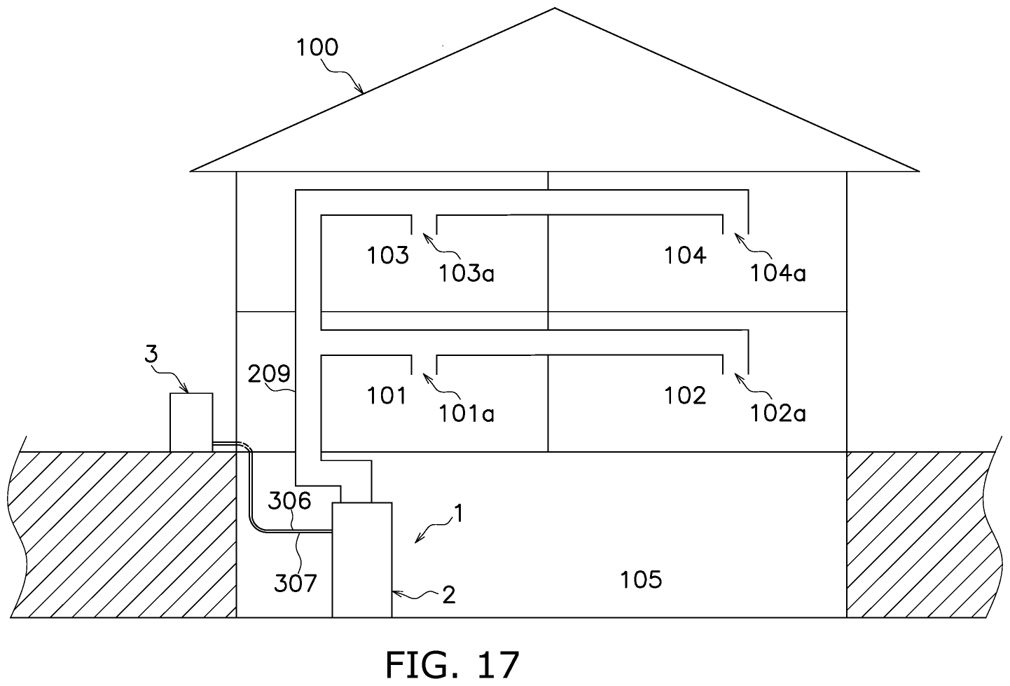

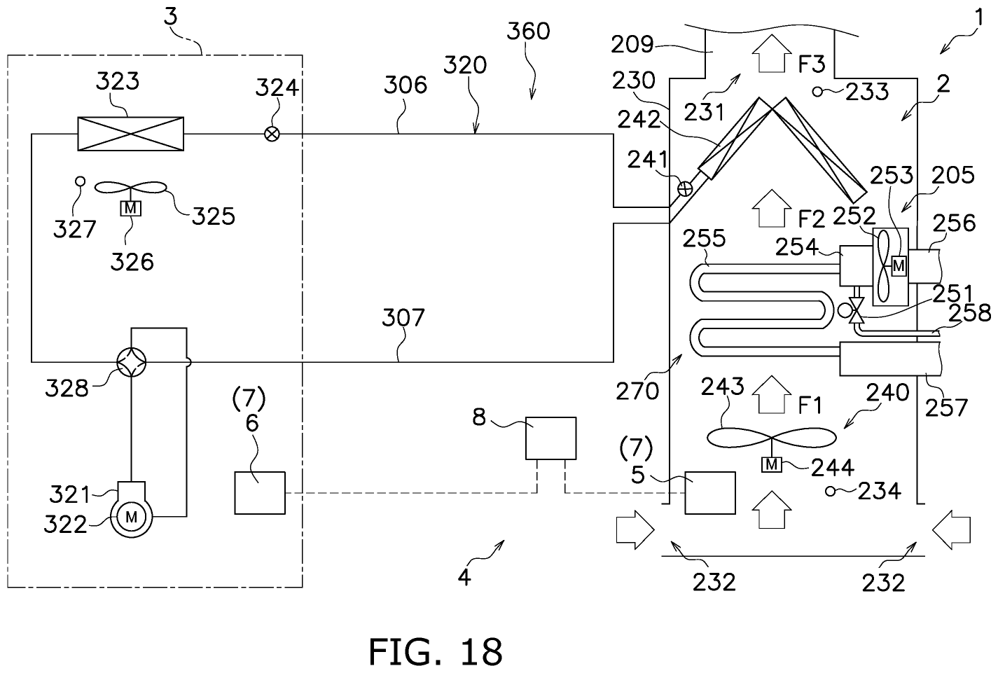

FIG. 17 is an exemplary view showing an arrangement of an air conditioning system 1 according to an embodiment. FIG. 18 is a schematic configuration diagram of the air conditioning system 1. In FIGS. 17 and 18, the air conditioning system 1 is a device used for air conditioning of a house or a building.

Here, the air conditioning system 1 is installed in a two-story house 100. In the house 100, rooms 101 and 102 are provided on the first floor, and rooms 103 and 104 are provided on the second floor. In addition, the house 100 is provided with a basement 105.

The air conditioning system 1 is a so-called duct air conditioning system. The air conditioning system 1 has an indoor unit 2, an outdoor unit 3, a liquid connection pipe 306, a gas connection pipe 307, and a duct 209 that sends air that has been air-conditioned by the indoor unit 2 to the rooms 101 to 104. The duct 209 is branched into the rooms 101 to 104, and is connected to ventilation ports 101a to 104a of the individual rooms 101 to 104. For convenience of description, the indoor unit 2, the outdoor unit 3, the liquid connection pipe 306, and the gas connection pipe 307 are collectively referred to as an air conditioner 4.

In FIG. 18, the indoor unit 2, the outdoor unit 3, the liquid connection pipe 306, and the gas connection pipe 307 constitute a heat pump unit 360 that heats a room by a vapor compression refrigeration cycle. Further, a gas furnace unit 205, which is a part of the indoor unit 2, constitutes a separate heat source unit 270 that heats a room by a heat source (here, heat from gas combustion) separate from the heat pump unit 360.

As described above, in addition to a part that constitutes the heat pump unit 360, the indoor unit 2 has the gas furnace unit 205 that constitutes the separate heat source unit 270. In addition, the indoor unit 2 also has an indoor fan 240 that takes in air in the rooms 101 to 104 into a housing 230 and supplies the air that has been air-conditioned by the heat pump unit 360 and the separate heat source unit 270 (the gas furnace unit 205) into the rooms 101 to 104. In addition, the indoor unit 2 is provided with a blow-out air temperature sensor 233 that detects a blow-out air temperature Trd, which is a temperature of air at an air outflow port 231 of the housing 230, and an indoor temperature sensor 234 that detects an indoor temperature Tr, which is a temperature of air at an air inflow port 232 of the housing 230. Note that the indoor temperature sensor 234 may be provided in the rooms 101 to 104 instead of the indoor unit 2.

### (2-2) Heat Pump Unit 360

In the heat pump unit 360 of the air conditioner 4, a refrigerant circuit 320 is configured by connecting the indoor unit 2 and the outdoor unit 3 via the liquid connection pipe 306 and the gas connection pipe 307. The liquid connection pipe 306 and the gas connection pipe 307 are refrigerant pipes constructed on site when the air conditioner 4 is installed.

The refrigerant circuit 320 is filled with a refrigerant. Here, the refrigerant is not limited, but a refrigerant including only CF₃I or a mixed refrigerant including CF₃I is used. As such a refrigerant, for example, a refrigerant such as R466A which is a refrigerant containing R32, R125, and CF₃I can be used. Here, the content of CF₃I in the refrigerant is not limited, but may be, for example, 5 wt % or more and 70 wt % or less, and is preferably 20 wt % or more and 50 wt % or less. Refrigerating machine oil is sealed in the refrigerant circuit 320 together with the refrigerant.

The indoor unit 2 is installed in the basement 105 of the house 100. Note that an installation location of the indoor unit 2 is not limited to the basement 105, and may be installed at another indoor place. The indoor unit 2 includes an indoor heat exchanger 242 as a refrigerant radiator that heats air through heat radiation from a refrigerant in the refrigeration cycle, and an indoor expansion valve 241.

During a cooling operation, the indoor expansion valve 241 decompresses the refrigerant circulating in the refrigerant circuit 320, and causes the refrigerant to flow through the indoor heat exchanger 242. Here, the indoor expansion valve 241 is an electric expansion valve connected to a liquid side of the indoor heat exchanger 242. The indoor expansion valve 241 includes a valve body, a valve seat, and a coil that moves the valve body, and any one of the valve body, the valve seat, and the coil contains aluminum or an aluminum alloy.

The indoor heat exchanger 242 is arranged on a most leeward side of a ventilation path from the air inflow port 232 to the air outflow port 231 formed in the housing 230. The indoor heat exchanger 242 includes heat transfer tubes and fins, and the heat transfer tubes through which the refrigerant flows contain aluminum or an aluminum alloy.

The outdoor unit 3 is installed outside of the house 100. The outdoor unit 3 has a compressor 321, an outdoor heat exchanger 323, an outdoor expansion valve 324, and a four-way switching valve 328. The compressor 321 is a hermetic compressor that houses, in a casing, a compression element (not illustrated) and a compressor motor 322 that drives the compression element. The compressor 321 is a scroll compressor or a rotary compressor.

When the compressor is a scroll compressor, at least one of a movable scroll, a fixed scroll, an Oldham ring, a slider, a sleeve, and a crankshaft contains aluminum or an aluminum alloy. When the compressor is a rotary compressor, at least one of a piston, a cylinder, and a crankshaft contains aluminum or an aluminum alloy.

The compressor motor 322 is supplied with electric power via an inverter device (not illustrated), and allows an operating capacity to be varied by changing a frequency (that is, a number of revolutions) of the inverter device.

The outdoor heat exchanger 323 is a heat exchanger that functions as a refrigerant evaporator that evaporates the refrigerant in the refrigeration cycle by outdoor air. The outdoor heat exchanger 323 includes heat transfer tubes and fins, and the heat transfer tubes through which the refrigerant flows contain aluminum or an aluminum alloy. Near the outdoor heat exchanger 323, an outdoor fan 325 that sends outdoor air to the outdoor heat exchanger 323 is provided. The outdoor fan 325 is rotationally driven by an outdoor fan motor 326.

During a heating operation, the outdoor expansion valve 324 decompresses the refrigerant circulating in the refrigerant circuit 320, and causes the refrigerant to flow through the outdoor heat exchanger 323. Here, the outdoor expansion valve 324 is an electric expansion valve connected to a liquid side of the outdoor heat exchanger 323. The outdoor expansion valve 324 includes a valve body, a valve seat, and a coil that moves the valve body, and any one of the valve body, the valve seat, and the coil contains aluminum or an aluminum alloy. Further, the outdoor unit 3 is provided with an outdoor temperature sensor 327 that detects a temperature of outdoor air outside of the house 100 where the outdoor unit 3 is arranged, that is, an outside air temperature Ta.

The four-way switching valve 328 is a valve to switch a refrigerant flow direction.

During a cooling operation, the four-way switching valve 328 connects a discharge side of the compressor 321 and a gas side of the outdoor heat exchanger 323, and also connects a suction side of the compressor 321 and the gas connection pipe 307 (a cooling operation state: see a solid line of the four-way switching valve 328 in FIG. 18). As a result, the outdoor heat exchanger 323 functions as a refrigerant condenser, and the indoor heat exchanger 242 functions as a refrigerant evaporator.

During a heating operation, the four-way switching valve 328 connects a discharge side of the compressor 321 and the gas connection pipe 307, and also connects a suction side of the compressor 321 and a gas side of the outdoor heat exchanger 323 (a heating operation state: see a broken line of the four-way switching valve 328 in FIG. 18). As a result, the indoor heat exchanger 242 functions as a refrigerant condenser, and the outdoor heat exchanger 323 functions as a refrigerant evaporator.

### (2-3) Separate Heat Source Unit 270

The separate heat source unit 270 is configured by the gas furnace unit 205 that is a part of the indoor unit 2 of the air conditioner 4.

The gas furnace unit 205 is provided in the housing 230 installed in the basement 105 of the house 100. The gas furnace unit 205 is a gas combustion heating device, and includes a fuel gas valve 251, a furnace fan 252, a combustion unit 254, a furnace heat exchanger 255, an air supply pipe 256, and an exhaust pipe 257.

The fuel gas valve 251 is configured by an electromagnetic valve or the like controlled to open and close, and is provided in a fuel gas supply pipe 258 extending from outside of the housing 230 to the combustion unit 254. As the fuel gas, natural gas, petroleum gas, and the like are used.

The furnace fan 252 is a fan that generates an air flow of taking in air into the combustion unit 254 through the air supply pipe 256, then sending the air to the furnace heat exchanger 255, and discharging from the exhaust pipe 257. The furnace fan 252 is rotationally driven by a furnace fan motor 253.

The combustion unit 254 is a device that obtains high-temperature combustion gas by burning mixed gas of fuel gas and air, with a gas burner or the like (not illustrated).

The furnace heat exchanger 255 is a heat exchanger that heats air by heat radiation from the combustion gas obtained in the combustion unit 254, and functions as a separate heat source radiator that heats air by heat radiation from a heat source (here, heat from gas combustion) that is separate from the heat pump unit 360.

In the ventilation path from the air inflow port 232 to the air outflow port 231 formed in the housing 230, the furnace heat exchanger 255 is located on a windward side of the indoor heat exchanger 242 as a refrigerant radiator.

### (2-4) Indoor Fan 240

The indoor fan 240 is a fan for supply, into the rooms 101 to 104, of air heated by the indoor heat exchanger 242 as a refrigerant radiator that constitutes the heat pump unit 360, and the furnace heat exchanger 255 as a separate heat source radiator that constitutes the separate heat source unit 270.

In the ventilation path from the air inflow port 232 to the air outflow port 231 formed in the housing 230, the indoor fan 240 is located on a windward side of both the indoor heat exchanger 242 and the furnace heat exchanger 255. The indoor fan 240 has a blade 243 and a fan motor 244 that rotationally drives the blade 243.

### (2-5) Controller 7

The indoor unit 2 is equipped with an indoor-side control board 5 that controls an operation of each part of the indoor unit 2. The outdoor unit 3 is equipped with an outdoor-side control board 6 that controls an operation of each part of the outdoor unit 3. Then, the indoor-side control board 5 and the outdoor-side control board 6 have a microcomputer or the like, and exchange control signals or the like with a thermostat 8. Further, the control signal is not exchanged between the indoor-side control board 5 and the outdoor-side control board 6. The control device including the indoor-side control board 5 and the outdoor-side control board 6 is called a controller 7.

The indoor-side control board 5 and the outdoor-side control board 6 constituting the controller 7 are electrically connected to each other so as to be able to communicate with each other via the thermostat 8.

The thermostat 8 is attached in an indoor space in the same manner as the indoor unit 2. Note that places where the thermostat 8 and the indoor unit 2 are attached may be different places in the indoor space.

A transformer transforms a voltage of a commercial power source (not shown) to a usable low voltage, and then supplies the voltage to each of the indoor unit 2, the outdoor unit 3, and the thermostat 8 via power supply lines.

### (2-6) Filling of Refrigerant in Refrigerant Circuit

The refrigerant circuit 320 is filled with the refrigerant, and the moisture amount is adjusted such that the moisture content in the fluid containing the refrigerant, the refrigerating machine oil, the moisture, and the like flowing in the refrigerant circuit 320 is larger than a predetermined moisture content.

Specifically, the fluid flowing through the refrigerant circuit 320 contains moisture so as to have a moisture content larger than a moisture content at which corrosion caused by iodine occurs in a portion of the refrigerant circuit 320 that is in contact with the refrigerant and contains aluminum or an aluminum alloy.

Although not limited, in the present embodiment, the lower limit of the moisture content in the fluid flowing through the refrigerant circuit 320 can be set to 75 ppm and is preferably 140 ppm from the viewpoint of effectively suppressing corrosion caused by iodine in a portion containing aluminum or an aluminum alloy.

The upper limit of the moisture content in the fluid flowing through the refrigerant circuit 320 is not limited, but is preferably 10,000 ppm or less and more preferably 1,000 ppm or less from the viewpoint of suppressing corrosion of metal constituting the refrigerant circuit 320 and hydrolysis or deterioration (total acid value becomes 0.1 or more) of the refrigerant or the refrigerating machine oil caused by an excessively high moisture content.

The moisture content of the fluid flowing through the refrigerant circuit 320 is preferably determined for the fluid flowing through the outlet of the heat exchanger (the indoor heat exchanger 242 or the outdoor heat exchanger 323) functioning as a condenser for the refrigerant.

### (2-7) Characteristics of Second Embodiment

Conventionally, it has been generally considered that the corrosion of the metal constituting the refrigerant circuit is more likely to proceed as the moisture content in the fluid increases.

On the other hand, in an air conditioning system 1 of a second embodiment, a component containing aluminum or an aluminum alloy is used in a portion in contact with the refrigerant in the refrigerant circuit 320, and the refrigerant containing iodine such as CF₃I is filled as the refrigerant. As described above, when the refrigerant containing iodine comes into contact with a component including aluminum or an aluminum alloy, in order to suppress corrosion of the aluminum or the aluminum alloy caused by iodine, it is considered preferable that more than a certain amount of moisture is contained.

In the air conditioning system 1 of the second embodiment, the moisture content in the fluid flowing through the refrigerant circuit 320 is adjusted to be larger than a moisture content at which corrosion caused by iodine occurs in a portion containing aluminum or an aluminum alloy.

This makes it possible to suppress corrosion caused by iodine in a portion containing aluminum or an aluminum alloy.

### (3) Third Embodiment

In the second embodiment, the description has been given by exemplifying the case where the moisture is contained such that the moisture content of the fluid flowing through the refrigerant circuit 320 is larger than a moisture content at which corrosion caused by iodine occurs in a portion of the refrigerant circuit 320 that is in contact with the refrigerant and contains aluminum or an aluminum alloy, thereby suppressing the corrosion caused by iodine in the portion containing aluminum or an aluminum alloy.

On the other hand, the means for suppressing the corrosion caused by iodine in a portion containing aluminum or an aluminum alloy is not limited to the means of the second embodiment.

For example, an air conditioning system 1 according to a third embodiment may be configured such that the controller 7 controls the components of the refrigerant circuit 320 such that a maximum temperature of a portion in contact with the fluid flowing in the refrigerant circuit 320 is lower than a temperature at which corrosion caused by iodine occurs in a portion containing aluminum or an aluminum alloy. The specific configuration of the air conditioning system 1 of the third embodiment other than the control can be similar to that of the second embodiment, and thus the same reference numerals as those of the second embodiment will be used as examples for description.

Such control by the controller 7 is not limited, and examples thereof include control for preventing the driving frequency of the compressor 321 from becoming equal to or higher than a predetermined value, control for preventing the temperature of the refrigerant discharged from the compressor 321 from becoming equal to or higher than a predetermined temperature, and control for preventing the pressure of the refrigerant discharged from the compressor 321 from becoming equal to or higher than a predetermined pressure. Here, the control for preventing the temperature of the refrigerant discharged from the compressor 321 from becoming equal to or higher than the predetermined temperature is not limited, but may be realized by lowering the driving frequency of the compressor 321 and/or increasing the valve opening degree of the outdoor expansion valve 324. Similarly, the control for preventing the pressure of the refrigerant discharged from the compressor 321 from becoming equal to or higher than the predetermined pressure is not limited, but may be realized by lowering the driving frequency of the compressor 321 and/or increasing the valve opening degree of the outdoor expansion valve 324.

In the air conditioning system 1 according to the third embodiment, the maximum temperature of the portion in contact with the fluid flowing in the refrigerant circuit 320 is preferably lower than 175° C., more preferably lower than 150° C., for example.

As described above, in the air conditioning system 1 of the third embodiment, since the maximum temperature of the portion in contact with the fluid flowing in the refrigerant circuit 320 is lower than the temperature at which the corrosion caused by iodine occurs in a portion containing aluminum or an aluminum alloy, it is possible to effectively suppress the corrosion caused by iodine in the portion containing aluminum or an aluminum alloy which tends to occur as the temperature becomes higher.

### (4) Other Embodiments

(4-1)

In the third embodiment described above, the description has been given by exemplifying the case where the maximum temperature of the portion in contact with the fluid flowing in the refrigerant circuit 320 is lower than the temperature at which the corrosion caused by iodine occurs in the portion containing aluminum or an aluminum alloy.

Here, for example, when the scroll compressor described in the first embodiment is employed as the compressor 41, the portion having the maximum temperature in the refrigerant circuit may be the stator 492 having the coil. Therefore, the temperature of the stator 492 may be configured to be lower than the temperature at which corrosion caused by iodine occurs in a portion containing aluminum or an aluminum alloy.

In particular, when the movable scroll 484, the fixed scroll 482, the Oldham ring 499, the slider, the sleeve, the crankshaft 494, and the like, which are components of the scroll compressor, are made of metal containing aluminum or an aluminum alloy, it is possible to effectively suppress corrosion of these components of the scroll compressor by performing control such that the temperature of the stator 492 having the coil does not excessively increase.

(4-2)

The stator 492 having the coil according to the above item (4-1) may be made of copper, a copper alloy, iron, an alloy containing iron, stainless steel, or the like, which is metal other than aluminum or an aluminum alloy.

As a result, even if the temperature of the stator 492 having the coil increases, corrosion of the stator 492 itself having the coil is suppressed.

(4-3)

In each of the above embodiments, the case where the fluid containing the refrigerant and the refrigerating machine oil circulates in the refrigerant circuit has been described.

Here, the refrigerating machine oil is not limited, but for example, polyol ester (POE) or polyvinyl ether (PVE) can be used, and among them, polyol ester (POE) is preferable from the viewpoint of further suppressing corrosion.

In these refrigerating machine oils, for example, 3 wt % or less of an acid value inhibitor or an acid scavenger is preferably added as an additive to the refrigerating machine oil. By adjusting the blending amounts of the acid value inhibitor and the acid scavenger, the moisture content in the fluid containing the refrigerant and the refrigerating machine oil can be easily adjusted.

(4-4)

In the second embodiment, the description has been given by exemplifying the case where, in the determination of the moisture content in the fluid flowing through the refrigerant circuit 320, the moisture content is determined for the fluid flowing through the outlet of the heat exchanger (the indoor heat exchanger 242 or the outdoor heat exchanger 323) functioning as the condenser for the refrigerant.

On the other hand, for example, instead of the fluid flowing through the outlet of the condenser, the moisture content of the fluid at the portion having the maximum temperature in the refrigerant circuit may be determined.

(4-5)

In the above embodiment, the description has been given by exemplifying the component containing aluminum or an aluminum alloy in contact with the fluid flowing through the refrigerant circuit.

On the other hand, with respect to the component in contact with the fluid flowing through the refrigerant circuit, only the contact portion or the entire component may be made of a non-metallic material such as ceramic or resin. This makes it possible to suppress corrosion of aluminum or an aluminum alloy caused by iodine.

(4-6)

All or one or more of the expansion valve 44, the indoor expansion valve 241, and the outdoor expansion valve 324 described in the above embodiment may be, for example, an expansion valve 70 having a configuration described below.

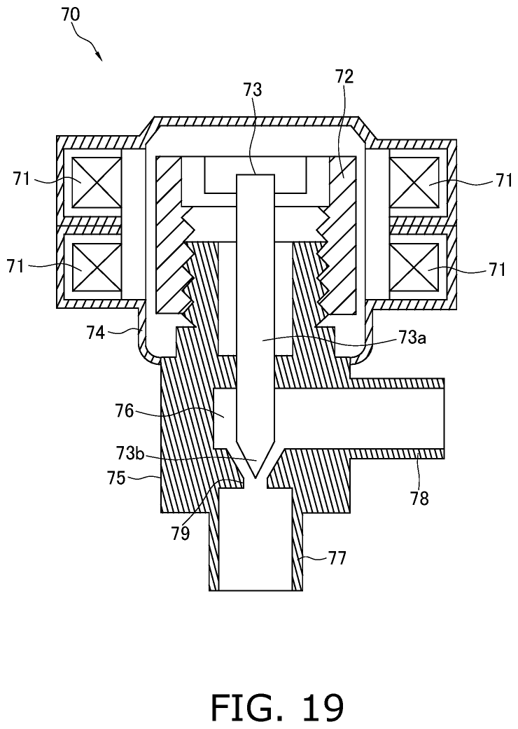

The expansion valve 70 is a motor expansion valve using a valve body 73 having a needle 73b as shown in FIG. 19. The expansion valve 70 mainly includes a coil 71, a rotor 72, the valve body 73, a casing 74, a valve seat member 75, and the like.

The coil 71 is provided in the circumferential direction when the longitudinal direction of the valve body 73 is the axial direction.

The rotor 72 is rotationally driven by the coil 71. The rotor 72 rotates to move in the screw axial direction.

The valve body 73 includes a shaft 73a and the needle 73b. The shaft 73a has a cylindrical shape and extends vertically, is attached so that one end thereof is coaxial with the rotor 72, and moves in the axial direction together with the rotor 72. The needle 73b is provided in a conical shape facing downward at the lower end of the shaft 73a. The needle 73b protrudes into a valve body side space 76 described later.

The casing 74 accommodates the coil 71, the rotor 72, the shaft 73a of the valve body 73, and the like therein.

The valve seat member 75 is provided below the casing 74. The valve seat member 75 includes a first coupling portion 77, a second coupling portion 78, a valve body side space 76 for communicating the first coupling portion 77 and the second coupling portion 78, and a valve seat 79 provided between the valve body side space 76 and the first coupling portion 77. The valve seat 79 is formed in a funnel shape so as to face the needle 73b of the valve body 73 from below on the radially outer side.

In this manner, the high-pressure liquid refrigerant flowing from the first coupling portion 77 or the second coupling portion 78 passes through the gap between the needle 73b and the valve seat 79 to be decompressed. The degree of decompression at that time is adjusted by moving the valve body 73 forward and backward by the rotation of the rotor 72 to change the size of the gap between the needle 73b and the valve seat 79.

(4-7)

Both or one of the four-way valve 42 and the four-way switching valve 328 described in the above embodiment may be, for example, the switching valve 9 having a configuration described below.

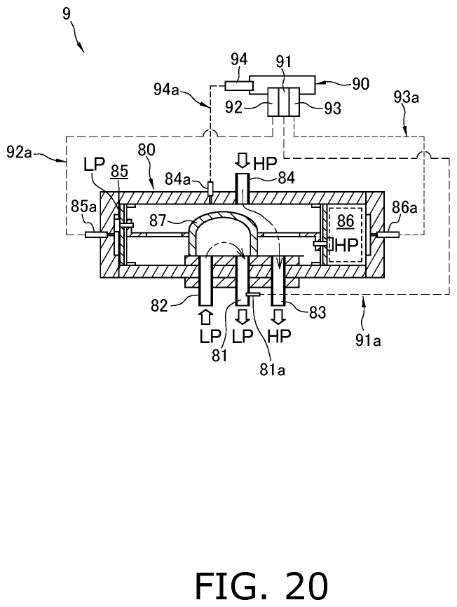

As shown in FIG. 20, the switching valve 9 includes a four-way switching valve body 80, a pilot electromagnetic valve 90 for switching the connection state, a high-pressure citation pipe 94a, a low-pressure citation pipe 91a, a first pilot pipe 92a, and a second pilot pipe 93a.

In the drawing, “LP” indicates the pressure of the refrigerant sucked into the compressor 41 or 321, and “HP” indicates the pressure of the refrigerant discharged from the compressor 41 or 321.

The four-way switching valve body 80 includes four connection ports of a first connection port 81, a second connection port 82, a third connection port 83, and a fourth connection port 84, a valve body 87, a first chamber 85, a second chamber 86, a first communication portion 85a, a second communication portion 86a, a high-pressure citation portion 84a, and a low-pressure citation portion 81a.

A discharge pipe extending from the discharge side of the compressor 41 or 321 is connected to the fourth connection port 84 of the four-way switching valve body 80. A suction pipe is connected to the first connection port 81 of the four-way switching valve body 80. A pipe connected to the refrigerant pipe 13 or the gas connection pipe 307 is connected to the second connection port 82 of the four-way switching valve body 80. A pipe extending from a gas-side end portion of the heat-source-side heat exchanger 43 or the outdoor heat exchanger 323 is connected to the third connection port 83 of the four-way switching valve body 80.

In the first connection state, in the four-way switching valve body 80, the valve body 87 is located at a first position so that the fourth connection port 84 and the third connection port 83 communicate with each other and the second connection port 82 and the first connection port 81 communicate with each other. Accordingly, in the first connection state, the refrigerant discharged from the discharge side of the compressor 41 or 321 sequentially flows through the discharge pipe, the fourth connection port 84, and the third connection port 83, and is supplied to the gas-side end portion of the heat-source-side heat exchanger 43 or the outdoor heat exchanger 323. In the first connection state, the refrigerant that has flowed through the refrigerant pipe 13 or the gas connection pipe 307 flows through the second connection port 82, the first connection port 81, and the suction pipe, and is sent to the suction side of the compressor 41 or 321.

In the second connection state, in the four-way switching valve body 80, the valve body 87 is located at a second position so that the fourth connection port 84 and the second connection port 82 communicate with each other and the third connection port 83 and the first connection port 81 communicate with each other. Accordingly, in the second connection state, the refrigerant discharged from the discharge side of the compressor 41 or 321 sequentially flows through the discharge pipe, the fourth connection port 84, and the second connection port 82, and is supplied to the refrigerant pipe 13 or the gas connection pipe 307. In the second connection state, the refrigerant that has passed through the gas-side end portion of the heat-source-side heat exchanger 43 or the outdoor heat exchanger 323 flows through the third connection port 83, the first connection port 81, and the suction pipe, and is sent to the suction side of the compressor 41 or 321.

The valve body 87 is located so as to be sandwiched between the first chamber 85 and the second chamber 86 inside the four-way switching valve body 80. The valve body 87 is provided so as to separate a space on the first connection port 81 side and a space on the fourth connection port 84 side. The valve body 87 slides according to the pressure acting on the first chamber 85 and the second chamber 86. Specifically, in a state where a low pressure acts on the first chamber 85 and a high pressure acts on the second chamber 86, the valve body 87 slides to reduce the first chamber 85 and increase the second chamber 86, so that the fourth connection port 84 and the third connection port 83 communicate with each other, and the second connection port 82 and the first connection port 81 communicate with each other. In addition, in a state where a high pressure acts on the first chamber 85 and a low pressure acts on the second chamber 86, the valve body 87 slides to increase the first chamber 85 and reduce the second chamber 86, so that the fourth connection port 84 and the second connection port 82 communicate with each other, and the third connection port 83 and the first connection port 81 communicate with each other.

The first chamber 85 is provided with the first communication portion 85a. The first pilot pipe 92a that is a capillary tube extending from the pilot electromagnetic valve 90 is connected to the first communication portion 85a. As a result, the refrigerant pressure of the first pilot pipe 92a acts on the first chamber 85.

The second chamber 86 is provided with the second communication portion 86a. The second pilot pipe 93a that is a capillary tube extending from the pilot electromagnetic valve 90 is connected to the second communication portion 86a. As a result, the refrigerant pressure of the second pilot pipe 93a acts on the second chamber 86.

The high-pressure citation portion 84a is provided in a space other than the first chamber 85 and the second chamber 86 in the internal space of the four-way switching valve body 80 and where the fourth connection port 84 is located by being partitioned by the valve body 87. The high-pressure citation pipe 94a that is a capillary tube extending from the pilot electromagnetic valve 90 is connected to the high-pressure citation portion 84a. As a result, the pressure of the high-pressure refrigerant passing through the fourth connection port 84 can be guided to the pilot electromagnetic valve 90.

The low-pressure citation portion 81a is provided in the first connection port 81. The low-pressure citation pipe 91a that is a capillary tube extending from the pilot electromagnetic valve 90 is connected to the low-pressure citation portion 81a. As a result, the pressure of the low-pressure refrigerant passing through the first connection port 81 can be guided to the pilot electromagnetic valve 90.

The pilot electromagnetic valve 90 includes four ports of the high-pressure citation port 94, the low-pressure citation port 91, a first action port 92, and a second action port 93.

The high-pressure citation port 94 is connected to the high-pressure citation portion 84a via the high-pressure citation pipe 94a. The low-pressure citation port 91 is connected to the low-pressure citation portion 81a via the low-pressure citation pipe 91a. The first action port 92 is connected to the first communication portion 85a via the first pilot pipe 92a. The second action port 93 is connected to the second communication portion 86a via the second pilot pipe 93a.

The main controller 60 or the controller 7 generates a magnetic field in an excitation coil (not shown) included in the pilot electromagnetic valve 90 and moves the valve portion against a force received from a spring or the like to switch between a first connection state in which the refrigerant pressure citation in the low-pressure citation port 91 acts on the first action port 92 while the refrigerant pressure citation in the high-pressure citation port 94 acts on the second action port 93 and a second connection state in which the refrigerant pressure citation in the low-pressure citation port 91 acts on the second action port 93 while the refrigerant pressure citation in the high-pressure citation port 94 acts on the first action port 92 when no voltage is applied.

(4-8)

The refrigerant circuit 11 or the refrigerant circuit 320 described in the above embodiment is configured by connecting a plurality of refrigerant pipes to each other. These refrigerant pipes may include, for example, a flare connection portion 150 described below.

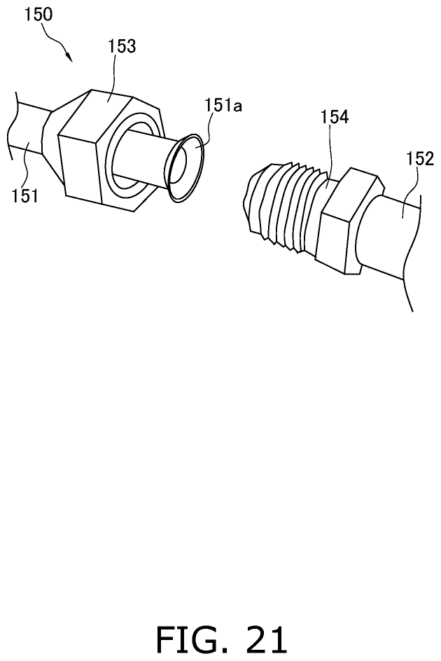

As shown in FIG. 21, the flare connection portion 150 includes a flare nut 153, a joint body 154, an O-ring (not shown), and the like.

Here, a case where the first refrigerant pipe 151 and the second refrigerant pipe 152 constituting a part of the refrigerant circuit 11 or the refrigerant circuit 320 are connected will be described as an example.

The end portion of the first refrigerant pipe 151 has a flared portion 151a whose diameter increases toward the end portion. The flare nut 153 is provided on the first refrigerant pipe 151 side having the flared portion 151a.

The end portion of the second refrigerant pipe 152 is fixed to the joint body 154. The joint body 154 is a cylindrical member having a screw groove corresponding to the screw groove provided on the inner periphery of the flare nut 153 on the outer periphery, and has a shape corresponding to the flared portion 151a in a portion facing the flared portion 151a.

In the above configuration, the first refrigerant pipe 151 and the second refrigerant pipe 152 are coupled by screwing the flare nut 153 to the joint body 154.

The embodiment of the present disclosure has been described above. It will be appreciated that various modifications to modes and details can be made without departing from the spirit and the scope of the present disclosure described in the appended claims.

### REFERENCE SIGNS LIST

1: air conditioning system (refrigerant cycle apparatus)
4: air conditioner (refrigerant cycle apparatus)
10: air conditioner (refrigerant cycle apparatus)
11: refrigerant circuit
15: drier
16: bypass flow path
17: on-off valve (control valve)
41: compressor
43: heat-source-side heat exchanger (heat exchanger, condenser)
44: expansion valve (control valve)
45: utilization-side heat exchanger (heat exchanger, condenser)
45a: heat transfer tube (component of heat exchanger)
70: expansion valve (control valve)
71: coil (component part of control valve)
73: valve body (component part of control valve)
75: valve seat member (component part of control valve)
151: first refrigerant pipe (refrigerant pipe)
152: second refrigerant pipe (refrigerant pipe)
241: indoor expansion valve (control valve)
242: indoor heat exchanger (heat exchanger, condenser)
306: liquid connection pipe (connection pipe)
307: gas connection pipe (connection pipe)
320: refrigerant circuit
321: compressor
323: outdoor heat exchanger (heat exchanger, condenser)
324: outdoor expansion valve (control valve)
470: sleeve (component of compressor)
475: slider (component of compressor)
482: fixed scroll (component of compressor)
484: movable scroll (component of compressor)
485: balance weight (component of compressor)
494: crankshaft (component of compressor)
499: Oldham ring (component of compressor)
531: piston (component of compressor)
550: cylinder (component of compressor)
555: balance weight (component of compressor)
522: crankshaft (component of compressor)

### CITATION LIST

### Patent Literature

Patent Literature 1: JP 2017-149943 A

1. A refrigerant cycle apparatus comprising a refrigerant circuit through which a fluid containing iodine circulates,
wherein the refrigerant circuit includes a component that is in contact with the fluid,
wherein the component is made of metal in which a content of aluminum is equal to or less than a ratio at which corrosion of aluminum occurs by iodine, and
wherein the component is at least one of a component of a compressor, a component of a heat exchanger, a component of a control valve, a drier, a refrigerant pipe, and a connection pipe.

2. The refrigerant cycle apparatus according to claim 1, wherein the component of the heat exchanger is a heat transfer tube included in the heat exchanger.

3. The refrigerant cycle apparatus according to claim 1, wherein the component of the control valve is a valve body and/or a coil.

4. The refrigerant cycle apparatus according to claim 1,
wherein the compressor is a scroll compressor, and
wherein the component of the compressor is at least one of a movable scroll, a fixed scroll, an Oldham ring, a slider, a sleeve, a balance weight, and a crankshaft.

5. The refrigerant cycle apparatus according to claim 1,
wherein the compressor a rotary compressor, and
wherein the component of the compressor is at least one of a piston, a cylinder, a balance weight, and a crankshaft.

6. The refrigerant cycle apparatus according to claim 1, wherein the component does not contain aluminum.

7. A refrigerant cycle apparatus comprising a refrigerant circuit through which a fluid containing iodine circulates,
wherein the refrigerant circuit has a portion that is in contact with the fluid and is made of aluminum or an aluminum alloy,
wherein the refrigerant circuit has a portion where a moisture content of the fluid is larger than a predetermined moisture content, and
wherein the predetermined moisture content is a moisture content at which corrosion by iodine occurs in the portion made of the aluminum or the aluminum alloy,

8. The refrigerant cycle apparatus according to claim 7,
wherein the refrigerant circuit includes a condenser for a refrigerant, and
wherein a moisture content of the fluid flowing through an outlet of the condenser in the refrigerant circuit is larger than the predetermined moisture content.

9. (Currently Amen ed The refrigerant cycle apparatus according to claim 7, wherein he predetermined moisture content In the fluid is 75 ppm.

10. A refrigerant cycle apparatus comprising refrigerant circuit through which a fluid containing iodine circulates,
wherein the refrigerant circuit has a portion that is in contact with the fluid and is made of aluminum or an aluminum alloy,
wherein a maximum temperature of a portion in contact th the fluid flowing in the refrigerant circuit is lower than a predetermined temperature, and
wherein the predetermined temperature is a temperature at which corrosion by iodine occurs in the portion made of the aluminum or the aluminum alloy.

11. The refrigerant cycle apparatus according to claim 10, wherein the predetermined temperature is 175° C.

12. The refrigerant cycle apparatus according to claim 10,
wherein the refrigerant circuit includes a compressor, and
wherein the refrigerant cycle apparatus further includes a controller configured to control at least the compressor such that a maximum temperature of a portion that is in contact with the fluid flowing in the refrigerant circuit becomes lower than the predetermined temperature.

13. The refrigerant cycle apparatus according to claim 1, wherein the fluid includes a refrigerant containing CF₃I or a mixed refrigerant containing CF₃I.

14. The refrigerant cycle apparatus according to claim 1, wherein the fluid contains R466A.

15. The refrigerant cycle apparatus according to claim 2, wherein the component of the control valve is a valve body and/or a coil.

16. The refrigerant cycle apparatus according to claim 2,
wherein the compressor is a scroll compressor, and
wherein the component of the compressor is at least one of a movable scroll, a fixed scroll, an Oldham ring, a slider, a sleeve, a balance weight, and a crankshaft.

17. The refrigerant cycle apparatus according to claim 3,
wherein the compressor is a scroll compressor, and
wherein the component of the compressor is at least one of a movable scroll, a fixed scroll, an Oldham ring, a slider, a sleeve, a balance weight, and a crankshaft.

18. The refrigerant cycle apparatus according to claim 2,
wherein the compressor is a rotary compressor, and
wherein the component of the compressor is at least one of a piston, a cylinder, a balance weight, and a crankshaft.

19. The refrigerant cycle apparatus according to claim 3,
wherein the compressor is a rotary compressor, and
wherein the component of the compressor is at least one of a piston, a cylinder, a balance weight, and a crankshaft.

20. The refrigerant cycle apparatus according to claim 2, wherein the component does not contain aluminum.
